(19) United States
(12) Patent Application Publication
(10) Pub. No.: US 2026/0364460 A1
(43) Pub. Date: Nov. 19, 2026

(54) ELECTRONIC DEVICE, METHOD, AND NON-TRANSITORY COMPUTER-READABLE STORAGE MEDIUM FOR OBTAINING FEATURE VECTOR REPRESENTING TRAJECTORY OF PLAYER

(71) Applicant: NC Corporation, Seongnam-si (KR)

(72) Inventors: Hyunsoo KIM, Seongnam-si (KR); Jaeman SON, Seongnam-si (KR)

(73) Assignee: NC Corporation, Seongnam-si (KR)

(21) Appl. No.: 19/670,494

(22) Filed: May 7, 2026

(30) Foreign Application Priority Data
May 7, 2025 (KR) 10-2025-0059386

(51) Int. Cl. A63F 13/573; A63F 13/5372; A63F 13/5378

(52) U.S. Cl. CPC A63F 13/573; A63F 13/5372; A63F 13/5378

(57) ABSTRACT

According to an embodiment, an electronic device includes memory including instructions and one or more storage media and at least one processor including processing circuitry. The instructions, when executed by the at least one processor individually or collectively, cause the electronic device to identify a first location sequence including positions through which a first player character moves sequentially, identify a second location sequence including positions through which a second player character moves sequentially, by dividing the first location sequence, obtain a third location sequence included in the first location sequence, and a fourth location sequence, and provide, for training an AI model to be used to identify a feature vector value for a trajectory, first information on the third location sequence, second information on the fourth location sequence, and third information on the second location sequence to the AI model.

### CROSS-REFERENCE TO RELATED APPLICATION(S)

This application is based on and claims priority under 35 U.S.C. § 119(a), of a Korean patent application number 10-2025-0059386, filed on May 7, 2025, in the Ministry of Intellectual Property, the disclosure of which is incorporated by reference herein in its entirety.

### BACKGROUND

### 1. Field

The following descriptions relate to an electronic device, a method, and a non-transitory computer-readable storage medium for obtaining a feature vector representing a trajectory of a player.

### 2. Description of Related Art

An electronic device may train an artificial intelligence (AI) model by using training data so that the AI model recognizes a specific pattern or makes a specific decision. The electronic device may train the AI model indicated by a plurality of parameters. The electronic device may adjust the parameters in accordance with progress of the training of the AI model.

### SUMMARY

An electronic device is provided. The electronic device may comprise at least one processor including processing circuitry. The electronic device may comprise memory comprising one or more storage media storing instructions. The instructions, when executed by the at least one processor individually or collectively, may cause the electronic device to identify a first location sequence including positions within a game environment, through which a first player character moves sequentially. The instructions, when executed by the at least one processor individually or collectively, may cause the electronic device to identify a second location sequence including positions within a game environment through which a second player character different from the first player character moves sequentially. The instructions, when executed by the at least one processor individually or collectively, may cause the electronic device to, by dividing the first location sequence, obtain a third location sequence including first positions from among the positions included in the first location sequence, and a fourth location sequence including second positions from among the positions included in the first location sequence. The first positions and the second positions may be determined alternately. The instructions, when executed by the at least one processor individually or collectively, may cause the electronic device to provide, for training an artificial intelligence (AI) model to be used to identify a feature vector value for a trajectory of a player character, first information on the third location sequence, second information on the fourth location sequence, and third information on the second location sequence to the AI model. The AI model may be trained to identify, based on the first information, the second information, and the third information, that a first feature vector value associated with the first positions is closer to a second feature vector value associated with the second positions than to a third feature vector value associated with the second location sequence.

A non-transitory computer readable storage medium storing one or more programs is provided. The one or more programs may include instructions which, when executed by at least one processor of an electronic device, cause the electronic device to identify a first location sequence including positions within a game environment, through which a first player character moves sequentially. The one or more programs may include instructions which, when executed by the at least one processor, cause the electronic device to identify a second location sequence including positions within a game environment through which a second player character different from the first player character moves sequentially. The one or more programs may include instructions which, when executed by the at least one processor, cause the electronic device to, by dividing the first location sequence, obtain a third location sequence including first positions from among the positions included in the first location sequence, and a fourth location sequence including second positions from among the positions included in the first location sequence. The first positions and the second positions may be determined alternately. The one or more programs may include instructions which, when executed by the at least one processor, cause the electronic device to provide, for training an artificial intelligence (AI) model to be used to identify a feature vector value for a trajectory of a player character, first information on the third location sequence, second information on the fourth location sequence, and third information on the second location sequence to the AI model. The AI model may be trained to identify, based on the first information, the second information, and the third information, that a first feature vector value associated with the first positions is closer to a second feature vector value associated with the second positions than to a third feature vector value associated with the second location sequence.

A method performed by an electronic device is provided. The method may comprise identifying a first location sequence including positions within a game environment, through which a first player character moves sequentially. The method may comprise identifying a second location sequence including positions within a game environment through which a second player character different from the first player character moves sequentially. The method may comprise, by dividing the first location sequence, obtaining a third location sequence including first positions from among the positions included in the first location sequence, and a fourth location sequence including second positions from among the positions included in the first location sequence. The first positions and the second positions may be determined alternately. The method may comprise providing, for training an artificial intelligence (AI) model to be used to identify a feature vector value for a trajectory of a player character, first information on the third location sequence, second information on the fourth location sequence, and third information on the second location sequence to the AI model. The AI model may be trained to identify, based on the first information, the second information, and the third information, that a first feature vector value associated with the first positions is closer to a second feature vector value associated with the second positions than to a third feature vector value associated with the second location sequence.

### BRIEF DESCRIPTION OF THE DRAWINGS

FIG. 1 illustrates trajectories of automated gameplay bot users and a normal user within a game environment.

FIG. 2 is a simplified block diagram of an electronic device.

FIG. 3 is a flowchart illustrating an operation of training an artificial intelligence (AI) model that identifies a feature vector value by using a location sequence.

FIG. 4 illustrates a method of training an AI model by using information on a location sequence including first positions and information on a location sequence including second positions.

FIG. 5 illustrates a method of identifying an identifier corresponding to an area and a coordinate defined for the area.

FIG. 6 is a flowchart illustrating an operation of determining timing data included in information provided to an AI model.

FIG. 7 is a flowchart illustrating an operation of training an AI model by using a first portion and a second portion of a location sequence.

FIG. 8 illustrates a method of training an AI model by using a first portion and a second portion of a location sequence.

FIG. 9 is a flowchart illustrating an operation of training an AI model by using a location sequence obtained by masking a portion of first positions.

FIG. 10 illustrates a method of training an AI model by using a location sequence obtained by masking a portion of first positions.

FIG. 11 is a flowchart illustrating an operation of identifying a cluster including feature vector values by using a trained AI model.

FIG. 12 illustrates a method of identifying a cluster including feature vector values by using a trained AI model.

FIG. 13 is a flowchart illustrating an operation of displaying information on characters associated with feature vector values included in a cluster.

FIG. 14 illustrates information on characters displayed through a display.

FIG. 15 illustrates a map representing a positional relationship between feature vector values.

FIG. 16 is a flowchart illustrating an operation of identifying whether a character is included in a cluster based on an input representing an identifier of the character.

FIG. 17 illustrates a method of displaying information representing whether a character is included in a cluster based on an input representing an identifier of the character.

FIG. 18 illustrates a method of training an AI model by using contrastive learning and masked cell prediction (MCP).

FIG. 19 illustrates an example of clusters identified based on feature vector values.

### DETAILED DESCRIPTION

In the following description, embodiments of the present disclosure will be described in detail with reference to the drawings so that those skilled in the art in the technical field to which the present disclosure pertains may easily implement the present disclosure. However, the present disclosure may be implemented in various different forms and is not limited to the embodiments described herein. In relation to the description of the drawing, the same or similar reference numerals may be used for the same or similar components. In addition, in the drawings and the related description, descriptions of well-known functions and configurations may be omitted for clarity and conciseness.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

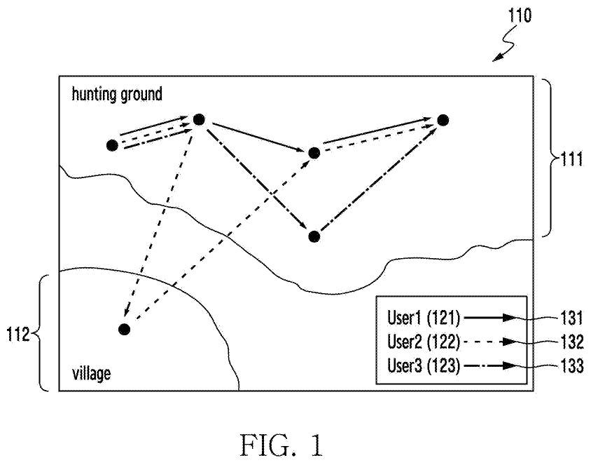

FIG. 1 illustrates trajectories of automated gameplay bot users and a normal user within a game environment.

Referring to FIG. 1, at least one processor of an electronic device may identify a trajectory of at least one player character within a game environment (virtual space). For example, the at least one processor may obtain a trajectory 131 of a first player character 121, a trajectory 132 of a second player character 122, and a trajectory 133 of a third player character 123. For example, positions included in a trajectory of a player character may include a hunting ground 111 and/or a village 112 within the virtual space.

For example, the at least one processor may identify two or more player characters (e.g., the first player character 121 and the second player character 122) of a bot user who plays by using an automation program and/or an application program. For example, the bot user may play the two or more player characters by using the automation program. For example, the at least one processor may identify a player character (e.g., the third player character 123) of a normal user who plays without use of the automation program and/or the application program. For example, the second player character 122 may be located within the village 112 for potion replenishment, selling of an in-game item, purchasing of an in-game item, and/or revival of the second player character 122.

Meanwhile, the at least one processor may identify that the trajectory 131 of the first player character 121 is more similar to the trajectory 133 of the third player character 123 than to the trajectory 132 of the second player character 122, when operating in accordance with a conventional technology for identifying that the player character play collectively by using the automation program and/or the application program. The at least one processor may identify that the first player character 121 and the third player character 123 are player characters of the bot user. In this case, although the second player character 122 is not a player character of the normal user, the second player character 122 may be identified as the player character of the normal user.

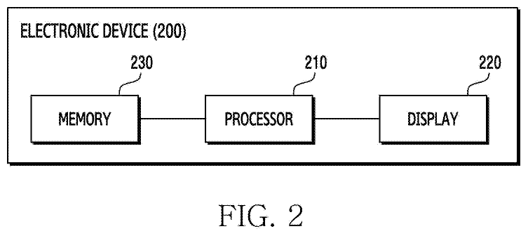

An electronic device described below (e.g., an electronic device 200 of FIG. 2) may identify that the first player character 121 and the second player character 122 play collectively by using the automation program and/or the application program, unlike the electronic device described with reference to FIG. 1. For example, the electronic device described below may identify that the third player character 123 plays individually without use of the automation program and/or the application program, unlike the electronic device described with reference to FIG. 1. The electronic device described below may identify that the first player character 121 and the second player character 122 play collectively by using the automation program and/or the application program by using an AI model for identifying a feature vector value representing a trajectory of a player character, unlike the electronic device described with reference to FIG. 1.

FIG. 2 is a simplified block diagram of an electronic device.

Referring to FIG. 2, an electronic device 200 may include at least one processor 210, a display 220, and memory 230. Some of components (e.g., the at least one processor 210, the display 220, and the memory 230) of the electronic device 200 illustrated in FIG. 2 may be omitted from the electronic device 200. For example, the display 220 may be omitted from the electronic device 200.

For example, the at least one processor 210 may be operatively (or operably) coupled with and/or connected with the display 220 and/or the memory 230. The at least one processor 210 being operatively coupled with or connected with the display 220 and/or the memory 230 may mean that the at least one processor 210 may control the display 220 and/or the memory 230. For example, the display 220 and/or the memory 230 may be controlled by the at least one processor 210.

For example, the at least one processor 210 may include one or more processors including an application processor (AP) and/or a communication processor (CP). For example, the at least one processor 210 may be implemented as a single chip such as a system on chip (SoC), or may be implemented as a plurality of chips. For example, the at least one processor 210 may be implemented as single integrated circuitry. For example, the at least one processor 210 may include first integrated circuitry and second integrated circuitry. For example, the at least one processor 210 may be arranged in a distributed manner within the electronic device 200. For example, a portion of the at least one processor 210 may be physically spaced apart from another portion of the at least one processor 210. As a non-limiting example, the another portion of the at least one processor 210 may be spaced apart from the portion of the at least one processor 210, but the another portion of the at least one processor 210 may be connected to the portion of the at least one processor 210 through interface circuitry.

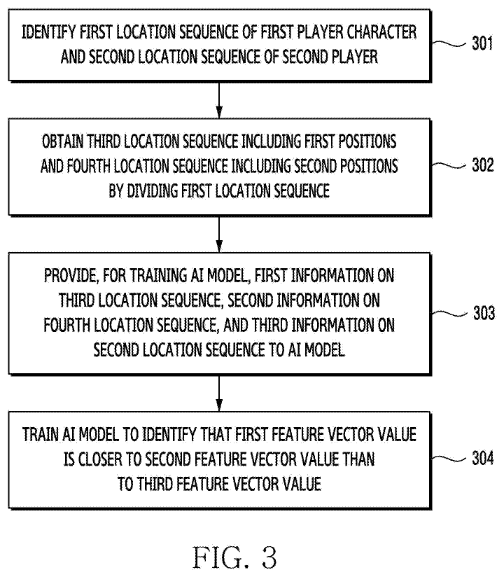

The at least one processor 210 may execute instructions stored in the memory 230 to cause the electronic device 200 to perform operations to be described with reference to FIGS. 3 to 19.

For example, the display 220 of the electronic device 200 may output visualized information (e.g., a screen) to a user. For example, the display 220 may output visualized information in accordance with control of a controller such as a graphic processing unit (GPU) (e.g., included in the at least one processor 210). The display 220 may include a liquid crystal display (LCD), a plasma display panel (PDP), and/or a light emitting diode (LED) display. The LED display may include an organic LED (OLED) display. The display 220 may be at least partially curved or deformable. The deformable display 220 may include a flexible display.

The memory 230 of the electronic device 200 may include circuitry and/or a storage medium for storing data and/or instructions inputted to and/or outputted from the at least one processor 210. The memory 230 may include, for example, a volatile memory such as a random-access memory (RAM) and/or a non-volatile memory such as a read-only memory (ROM). The non-volatile memory may be referred to as a storage. The volatile memory may include, for example, at least one of a dynamic RAM (DRAM), a static RAM (SRAM), a Cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, a solid state drive (SSD), and an embedded multi media card (eMMC).

For example, the memory 230 may be implemented as a single chip, or may be implemented as a plurality of chips. For example, the memory 230 may be implemented as single integrated circuitry, or may be implemented as a plurality of integrated circuitry (e.g., including first integrated circuitry and second integrated circuitry). For example, the memory 230 may be arranged in a distributed manner within the electronic device 200.

The memory 230 may store one or more programs configured to be executed individually or collectively by the at least one processor 210. The one or more programs may include at least a portion of instructions which, when executed by the at least one processor 210 individually or collectively, cause the electronic device 200 to perform operations to be described with reference to FIGS. 3 to 19.

FIG. 3 is a flowchart illustrating an operation of training an artificial intelligence (AI) model that identifies a feature vector value by using a location sequence. In the following embodiment, each operation may be performed sequentially, but is not necessarily performed sequentially. For example, an order of each operation may be changed, and at least two operations may be performed in parallel.

Referring to FIG. 3, in operation 301, at least one processor 210 may identify a first location sequence including positions within a game environment through which a first player character moves sequentially. The at least one processor 210 may identify a second location sequence including positions within a game environment through which a second player character different from the first player character moves sequentially.

For example, the at least one processor 210 may identify a location sequence including positions within a game environment through which a player character moves sequentially by obtaining location information of the player character based on a time period. As an example, the time period may be set by a user of an electronic device 200.

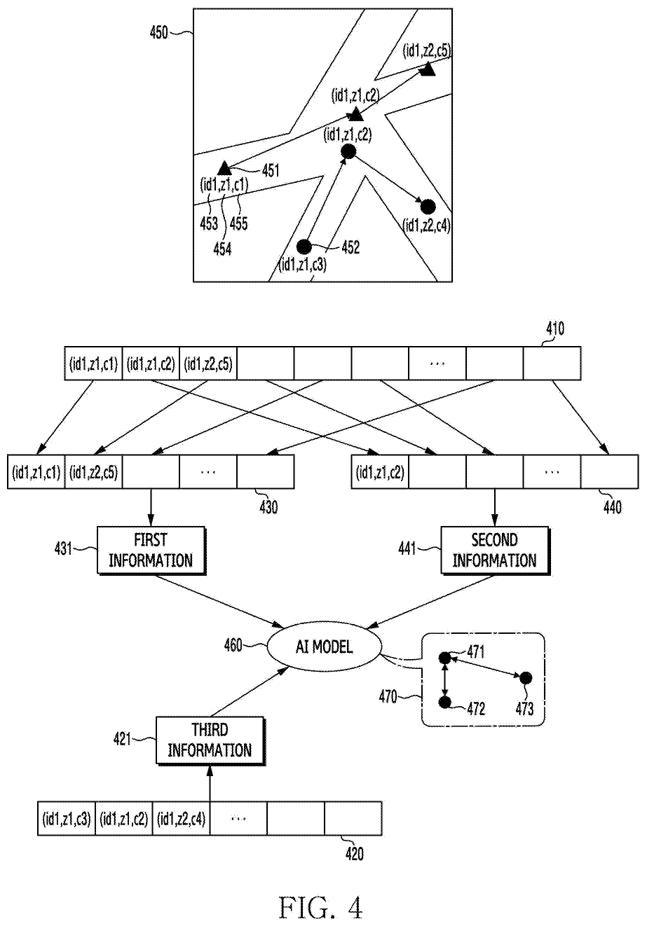

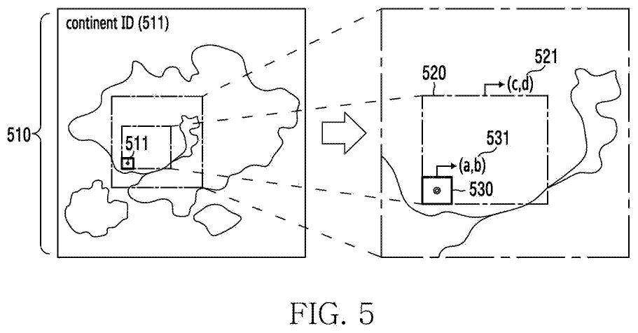

For example, the at least one processor 210 may represent each of the positions within the game environment as an identifier corresponding to an area and a coordinate of each of the positions defined for the area. The identifier corresponding to the area and the coordinate will be described later with reference to FIGS. 4 and 5.

For example, a trajectory of a player character may be discontinuous based on the player character using teleportation or the player character dying in a first position and then reviving in a second position distinct from the first position. As an example, a character may move a long distance within the game environment by using teleportation.

In operation 302, the at least one processor 210 may divide the first location sequence. For example, the at least one processor 210 may obtain a third location sequence including first positions from among the positions included in the first location sequence by dividing the first location sequence. The at least one processor 210 may obtain a fourth location sequence including second positions from among the positions included in the first location sequence. The first positions and the second positions may be determined alternately within the first location sequence. For example, the first positions and the second positions may be determined alternately within the first location sequence in an odd-even split manner. As a non-limiting example, a length of the first location sequence, the second location sequence, the third location sequence, and/or the fourth location sequence may be scalable. For example, the length of the first location sequence, the second location sequence, the third location sequence, and/or the fourth location sequence may be set by the user of the electronic device 200.

For example, the third location sequence divided from the first location sequence and the fourth location sequence divided from the first location sequence may be associated with the first player character and may not be associated with the second player character. Since the third location sequence and the fourth location sequence are associated with the first player character from among the first player character and the second player character, it may be required within the electronic device 200 to identify that a first feature vector value identified based on the third location sequence is closer to a second feature vector value identified based on the fourth location sequence than to a third feature vector value identified based on the second location sequence.

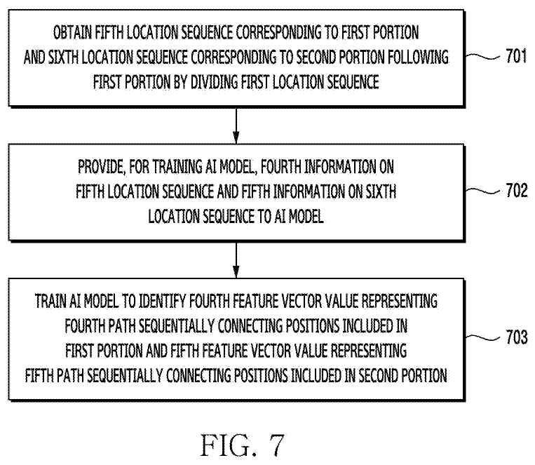

For example, the at least one processor 210 may divide the first location sequence by obtaining a fifth location sequence corresponding to a first portion of the first location sequence and a sixth location sequence corresponding to a second portion following the first portion. A method of obtaining the fifth location sequence and/or the sixth location sequence by dividing the first location sequence will be described later with reference to FIG. 7.

In operation 303, the at least one processor 210 may provide, for training an AI model to be used to identify a feature vector value for a trajectory of a player character, first information on the third location sequence, second information on the fourth location sequence, and third information on the second location sequence to the AI model.

For example, the AI model may be indicated by a plurality of parameters. As an example, the AI model may be a transformer model and/or an auto encoder model. As an example, the transformer model may learn a context of a trajectory of a player character. As an example, based on identifying a portion of the trajectory of the player character, the at least one processor 210 may identify, by using the transformer model, a trajectory predicted to be moved before and/or after the portion of the trajectory of the player character.

For example, a dimension of the feature vector value may be set by a user. The feature vector value may be projected on a vector space. Based on identifying two or more feature vector values on the vector space, the least one processor 210 may identify a distance between the feature vector values.

In operation 304, the at least one processor 210 may train the AI model, based on the first information, the second information, and the third information, such that the AI model identifies that the first feature vector value is closer to the second feature vector value than to the third feature vector value.

The first feature vector value may represent a first path sequentially connecting first positions included in the third location sequence. The second feature vector value may represent a second path sequentially connecting second positions included in the fourth location sequence. The third feature vector value may represent a third path sequentially connecting positions included in the second location sequence.

The AI model may be trained through a contrastive learning method. For example, the at least one processor 210 may project the first feature vector value, the second feature vector value, and the third feature vector value on the vector space. For example, the at least one processor 210 may identify a first distance between the first feature vector value and the second feature vector value. For example, the at least one processor 210 may identify a second distance between the first feature vector value and the third feature vector value. For example, the AI model may reduce the first distance between the first feature vector value and the second feature vector value in accordance with progress of training of the AI model. For example, the AI model may increase the second distance between the first feature vector value and the third feature vector value in accordance with the progress of the training of the AI model.

As described above, according to the operations described in FIG. 3, the at least one processor 210 may identify feature vector values representing trajectories of player characters without separate data labeling regarding whether the player characters are playing by using an automated program and/or an application program. The at least one processor 210 may identify that the trajectory 131 of the first player character 121 of FIG. 1 is more similar to the trajectory 132 of the second player character 122 of FIG. 1 than to the trajectory 133 of the third player character 123 of FIG. 1. The at least one processor 210 may identify that the first player character 121 and the second player character 122 are player characters of a bot user. The at least one processor 210 may identify that the third player character 123 is a player character of a normal user.

According to the above-described embodiment, in FIG. 1, although the second player character 122 is not a player character of a normal user, the second player character 122 is identified as a player character of a normal user, but the at least one processor 210 may identify the second player character 122 as a player character of a non-normal user (e.g., a bot user) and identify the third player character 123 as a player character of a normal user.

FIG. 4 illustrates a method of training an AI model by using information on a location sequence including first positions and information on a location sequence including second positions.

FIG. 5 illustrates a method of identifying an identifier corresponding to an area and a coordinate defined for the area.

Referring to FIG. 4, at least one processor 210 may obtain a first location sequence 410 including positions within a game environment 450 through which a first player character 451 moves sequentially. The at least one processor 210 may obtain a second location sequence 420 including positions within the game environment 450 through which a second player character 452 moves sequentially.

For example, the positions within the game environment 450 may be represented by an identifier corresponding to an area and a coordinate defined for the area. The identifier corresponding to the area and the coordinate defined for the area are described with reference to FIG. 5.

Referring to FIG. 5, the at least one processor 210 may identify that a player character is located within an area 510. The at least one processor 210 may identify the area 510 as an identifier 511 corresponding to the area.

A zone is described by a spatial unit included in an area. For example, the zone may be represented by a coordinate defined for the area. For example, a cell is included in the area and is described by a spatial unit smaller than the spatial unit of the zone. For example, the cell may be represented by a coordinate defined for the area.

For example, the at least one processor 210 may identify that a player character is located within a zone 520. The at least one processor 210 may identify the zone 520 as a coordinate 521 corresponding to the zone. The at least one processor 210 may identify that the player character is located within a cell 530. The at least one processor 210 may identify the cell 530 as a coordinate 531 corresponding to the cell.

For example, the at least one processor 210 may represent each of positions in FIG. 4 as an identifier 453 corresponding to an area, a coordinate 454 corresponding to a zone, and a coordinate 455 corresponding to a cell.

Referring again to FIG. 4, the identifier 453 corresponding to the area in FIG. 4 may indicate ‘id1’. For example, the coordinate 454 corresponding to the zone in FIG. 4 may indicate ‘z1’. As an example, the ‘z1’ may be represented in a coordinate format (e.g., (x1,y1) or (x1,y1,h1)). As an example, the coordinate 455 corresponding to the cell in FIG. 4 may indicate ‘c1’. As an example, the ‘c1’ may be represented in a coordinate format (e.g., (x2,y2) or (x2,y2,h2)). The h1 and the h2 exemplified above may be described as a coordinate value corresponding to a height axis in a 3D coordinate system.

The at least one processor 210 may obtain a third location sequence 430 including first positions from among the positions included in the first location sequence 410, and a fourth location sequence 440 including second positions from among the positions included in the first location sequence 410, by dividing the first location sequence 410. For example, the first positions and the second positions may be determined alternately with each other in the first location sequence.

For example, the at least one processor 210 may provide, for training an AI model 460 to be used to identify a feature vector value (e.g., a feature vector value 471, a feature vector value 472, or a feature vector value 473) for a trajectory of a player character, first information 431 on the third location sequence 430, second information 441 on the fourth location sequence 440, and third information 421 on a second location sequence 420 to the AI model 460.

For example, the at least one processor 210 may train the AI model 460 to identify that the first feature vector value 471 is closer to the second feature vector value 472 than to the third feature vector value 473, based on the first information 431, the second information 441, and the third information 421. The first feature vector value 471 may represent a first path sequentially connecting the first positions included in the third location sequence 430. The second feature vector value 472 may represent a second path sequentially connecting the second positions included in the fourth location sequence 440. The third feature vector value 473 may represent a third path sequentially connecting the positions included in the second location sequence 420.

For example, the third location sequence 430 may be described as a location sequence including odd-numbered positions in the first location sequence 410. For example, the fourth location sequence 440 may be described as a location sequence including even-numbered positions in the first location sequence 410. As an example, based on the at least one processor 210 identifying the third location sequence 430 including the odd-numbered positions in the first location sequence 410, and the fourth location sequence 440 including the even-numbered positions in the first location sequence 410, the number of positions included in the third location sequence 430 and the number of positions included in the fourth location sequence 440 may be identical or may differ by one.

For example, a path connecting positions through which a player character (e.g., the first player character 451 or the second player character 452) moves sequentially may be discontinuous. As an example, due to resurrection after death of a character, the player character may move from a hunting ground to a village far away from the hunting ground. As an example, the player character may move from the hunting ground to the village by using teleportation for purchasing of a potion, selling of an in-game item, and/or purchasing of an in-game item. After purchasing the potion, the player character may move from the village to the hunting ground by using the teleportation for in-game item acquisition or character growth. The at least one processor 210 may identify a context in which the player character moves from the hunting ground to the village and/or a context in which the player character moves from the village to the hunting ground.

For example, a path connecting positions included in a location sequence (e.g., the third location sequence 430, the fourth location sequence 440, or the second location sequence 420) may be discontinuous. The at least one processor 210 may provide, for training the AI model 460, the location sequence including positions included in the discontinuous path (e.g., the hunting ground or the village) to the AI model 460. The AI model 460 may be trained to identify a feature vector value representing a path in consideration of the context in which the player character moves from the hunting ground to the village and/or the context in which the player character moves from the village to the hunting ground.

The at least one processor 210 may accurately detect a bot user by using the AI model 460 trained in consideration of the context. A method for accurately detecting the bot user is described with reference to FIG. 1. Referring to FIG. 1, at least one processor of the electronic device 200 and another electronic device may identify that the first player character 121 of FIG. 1 and the third player character 123 of FIG. 1 are player characters of the bot user based on not identifying the context in which the player character moves from the hunting ground to the village and/or the context in which the player character moves from the village to the hunting ground. The at least one processor 210 of the electronic device 200 may identify that the first player character 121 of FIG. 1 and the second player character 122 of FIG. 1 are the player characters of the bot user by using the AI model 460 trained in consideration of the context.

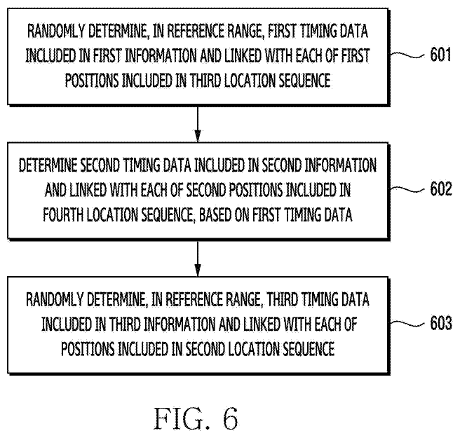

FIG. 6 is a flowchart illustrating an operation of determining timing data included in information provided to an AI model.

Referring to FIG. 6, in operation 601, at least one processor 210 may randomly determine, in a first reference range, first timing data included in first information on a third location sequence and linked with each of first positions included in the third location sequence. For example, the first timing data may represent information on an order between the first positions included in the third location sequence.

For example, the first timing data may include time information linked with one of the first positions. For example, the at least one processor 210 may randomly determine, in the first reference range, time information linked with an initial position among the first positions included in the third location sequence. The at least one processor 210 may identify a fifth place among the first positions included in the third location sequence, and a sixth place which follows the fifth place immediately. The at least one processor 210 may determine time information linked with the sixth position based on determining time information linked with the fifth position. For example, the time information linked with the fifth position and the time information linked with the sixth position may have a first time difference. As an example, the first time difference may be set by a user.

As an example, the at least one processor 210 may obtain information on a location of a player character in accordance with a reference period (e.g., 1 minute). The at least one processor 210 may identify a location sequence by obtaining the information on the location of the player character. The at least one processor 210 may identify 1440 positions within a game environment, through which the player character sequentially moves for 1440 minutes corresponding to one day. Based on a length of the third location sequence being 16, the reference range may be described as a range greater than 1 and smaller than 1424. The first information on the third location sequence may include 1001 which is the randomly determined time information linked with the initial position included in the third location sequence. As an example, the first time difference may be 1 minute. The time information linked with the fifth position and the time information linked with the sixth position may differ by 1 minute. Based on the time information corresponding to the initial position being 1001, the first timing data randomly determined and linked with the positions included in the third location sequence having the length of 16 may include 1001, 1002, 1003, 1004, 1005, 1006, 1007, 1008, 1009, 1010, 1011, 1012, 1013, 1014, 1015, and 1016.

In operation 602, the at least one processor 210 may determine second timing data included in second information on a fourth location sequence and linked with each of second positions included in the fourth location sequence, based on the first timing data. For example, the at least one processor 210 may identify the second timing data linked with each of the second positions as the first timing data linked with each of the first positions. As an example, based on the first timing data including 1001 to 1016, the second timing data may also include 1001 to 1016.

For example, the at least one processor 210 may determine the second timing data such that time information included in the second timing data has a second time difference from the time information included in the first timing data. For example, the second time difference may be randomly determined in a second reference range. The second reference range may be smaller than the first reference range. As an example, the second reference range may be determined in accordance with the first reference range.

As an example, the second reference range may be described as a range greater than or equal to −16 and less than or equal to 16. Based on the second reference range being a range greater than −16 and smaller than 16, the second time difference may be randomly determined in a range greater than −16 and smaller than 16. Based on the randomly determined second time difference being 5, the second timing data may be greater than the first timing data by 5. Based on the first timing data including 1001 to 1016, the second timing data may include 1006 to 1021.

In operation 603, the at least one processor 210 may randomly determine, in the first reference range, third timing data included in third information on a second location sequence and linked with each of the positions included in the second location sequence. The operation 603 may correspond to the operation 601. The at least one processor 210 may randomly determine the third timing data regardless of the first timing data and the second timing data.

FIG. 7 is a flowchart illustrating an operation of training an AI model by using a first portion and a second portion of a location sequence.

Referring to FIG. 7, in operation 701, at least one processor 210 may obtain a fifth location sequence corresponding to a first portion of a first location sequence and a sixth location sequence corresponding to a second portion of the first location sequence following the first portion of the first location sequence by dividing the first location sequence.

For example, the first portion and the second portion may be continuous in the first location sequence. For example, an initial position in the second portion of the first location sequence may be a position in the first location sequence, which follows a last position in the first portion of the first location sequence immediately.

For example, the number of positions included in the fifth location sequence and the number of positions included in the sixth location sequence may be identical. For example, the number of positions included in the fifth location sequence and the number of positions included in the sixth location sequence may be different. For example, a sum of the number of positions included in the fifth location sequence and the number of positions included in the sixth location sequence may be identical to the number of positions included in the first location sequence.

In operation 702, at least one processor 210 may provide, for training an AI model to be used to obtain a feature vector value, fourth information on the fifth location sequence and fifth information on the sixth location sequence to the AI model.

For example, the at least one processor 210 may provide, for training the AI model, the fourth information on the fifth location sequence, the fifth information on the sixth location sequence, first information on a third location sequence, second information on a fourth location sequence, and third information on a second location sequence to the AI model. According to an embodiment, the at least one processor 210 may provide the fourth information, the fifth information, and the third information to the AI model.

For example, the at least one processor 210 may randomly determine, in the first reference range, third timing data included in the fourth information and linked with each of the positions included in the fifth location sequence. For example, the third timing data may represent information on an order among the positions included in the fifth location sequence. For example, the at least one processor 210 may determine fourth timing data included in the fifth information and linked with each of the positions included in the sixth location sequence based on the third timing data. An operation of determining the third timing data and the fourth timing data may correspond to the operation 601 and the operation 602 of FIG. 6.

In operation 703, the at least one processor 210 may identify, by using an AI model 460, a fourth feature vector value representing a fourth path sequentially connecting positions included in the first portion of the first location sequence. The at least one processor 210 may identify, by using the AI model 460, a fifth feature vector value representing a fifth path sequentially connecting positions included in the second portion of the first location sequence. The at least one processor 210 may train the AI model 460 to identify that the fourth feature vector value and the fifth feature vector value are associated with each other. For example, the at least one processor 210 may train the AI model to identify that the fourth feature vector value is closer to the fifth feature vector value than to the third feature vector value described with reference to FIG. 3.

As described above, according to the operation described in FIG. 7, the at least one processor 210 may identify a feature vector value representing trajectories of player characters without separate data labeling regarding whether the player characters are playing by using an automated program and/or an application program. The at least one processor 210 may identify that the trajectory 131 of the first player character 121 of FIG. 1 is more similar to the trajectory 132 of the second player character 122 of FIG. 1 than to the trajectory 133 of the third player character 123 of FIG. 1, unlike the processor of FIG. 1. The at least one processor 210 may identify that the first player character 121 and the second player character 122 are player characters of a bot user. The at least one processor 210 may identify that the third player character 123 is a player character of a normal user.

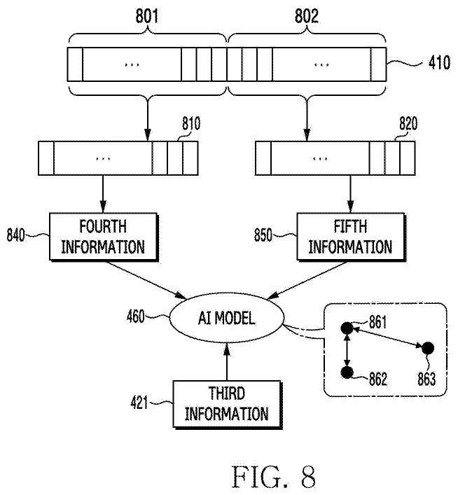

FIG. 8 illustrates a method of training an AI model by using a first portion and a second portion of a location sequence.

Referring to FIG. 8, at least one processor 210 may obtain a fifth location sequence 810 corresponding to a first portion 801 of a first location sequence 410 and a sixth location sequence 820 corresponding to a second portion 802 of the first location sequence 410 following the first portion 801 of the first location sequence 410 by dividing the first location sequence 410. For example, the first portion 801 and the second portion 802 may be continuous in the first location sequence 410.

For example, the at least one processor 210 may provide, for training an AI model 460, fourth information 840 on the fifth location sequence 810, fifth information 850 on the sixth location sequence 820, and third information 421 on a second location sequence (420 of FIG. 3) to the AI model 460.

For example, the at least one processor 210 may identify, by using the AI model 460, a fourth feature vector value 861 representing a fourth path sequentially connecting positions included in the first portion 801 of the first location sequence 410. The at least one processor 210 may identify, by using the AI model 460, a fifth feature vector value 862 representing a fifth path sequentially connecting positions included in the second portion 802 of the first location sequence 410. The at least one processor 210 may identify, by using the AI model 460, a third feature vector value 863 representing a third path sequentially connecting positions included in the second location sequence 420 of FIG. 3.

For example, the at least one processor 210 may train the AI model 460 to identify that the fourth feature vector value 861 and the fifth feature vector value 862 are associated with each other. As an example, the at least one processor 210 may train the AI model 460 to identify that the fourth feature vector value 861 is closer to the fifth feature vector value 862 than to the third feature vector value 863.

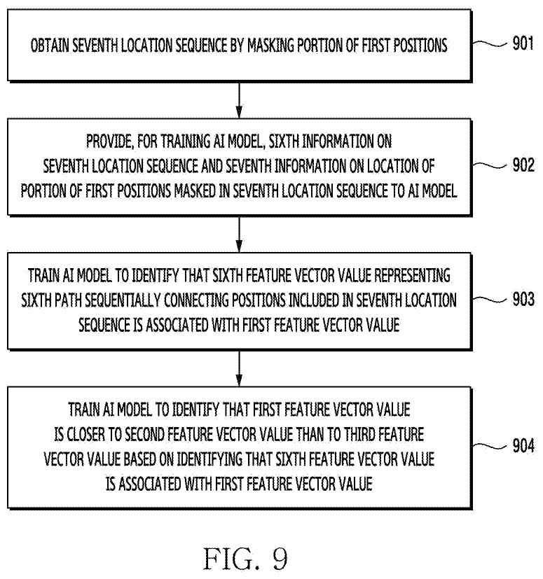

FIG. 9 is a flowchart illustrating an operation of training an AI model by using a location sequence obtained by masking a portion of first positions.

Referring to FIG. 9, in operation 901, at least one processor 210 may obtain a seventh location sequence by masking a portion of first positions included in a third location sequence. For example, the at least one processor 210 may randomly mask the first positions. For example, the at least one processor 210 may mask the first positions in accordance with a probability. The probability may be set by a user of an electronic device 200.

For example, the at least one processor 210 may mask the portion of the first positions by masking a coordinate (e.g., the coordinate 455 corresponding to the cell of FIG. 4) corresponding to a cell of the portion of the first positions included in the third location sequence.

In operation 902, the at least one processor 210 may provide, for training an AI model 460, sixth information on the seventh location sequence and seventh information on a location of the portion of the first positions masked in the seventh location sequence to the AI model 460. For example, the seventh information may be described as information on an index of the portion of the first positions masked in the seventh location sequence. For example, the information on the index may be described as information on the location of the portion of the first positions masked in the seventh location sequence.

In operation 903, the at least one processor 210 may identify, by using the AI model 460, a sixth feature vector value representing a sixth path sequentially connecting positions included in the seventh location sequence based on the sixth information and the seventh information. The at least one processor 210 may train the AI model 460 to identify that the sixth feature vector value and a first feature vector value are associated with each other.

In operation 904, the at least one processor 210 may train the AI model 460 to identify that the first feature vector value is closer to a second feature vector value (e.g., the second feature vector value 472 of FIG. 4) than to a third feature vector value (e.g., the third feature vector value 473 of FIG. 4) based on identifying that the sixth feature vector value and the first feature vector value are associated with each other.

For example, the at least one processor 210 may identify a first loss value required to train the AI model 460 to identify that the first feature vector value is closer to the second feature vector value than to the third feature vector value. For another example, the at least one processor 210 may identify the first loss value required to train the AI model 460 to identify that a fourth feature vector value is closer to a fifth feature vector value than to the third feature vector value. The at least one processor 210 may identify a second loss value required to train the AI model 460 to identify that the sixth feature vector value and the first feature vector value are associated with each other. For example, the at least one processor 210 may identify a third loss value based on an operation (e.g., a sum) of the first loss value and the second loss value. The at least one processor 210 may train the AI model 460 by using the third loss value.

As described above, according to the operation described in FIG. 9, the at least one processor 210 may train the AI model 460 such that the AI model 460 may more deeply learn a context associated with a trajectory of a player character by masking a portion of positions in the third location sequence provided to the AI model 460.

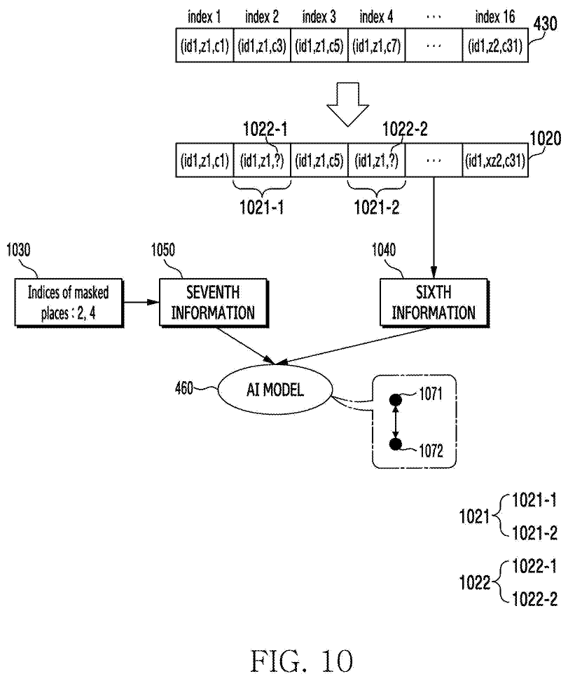

FIG. 10 illustrates a method of training an AI model by using a location sequence obtained by masking a portion of first positions.

Referring to FIG. 10, at least one processor 210 may obtain a seventh location sequence 1020 by masking a portion 1021-1 and 1021-2 of first positions included in a third location sequence 430. For example, the at least one processor 210 may obtain the seventh location sequence 1020 by masking coordinates 1022-1 and 1022-2 corresponding to a cell of the portion 1021-1 and 1021-2 of the first positions included in the third location sequence 430.

For example, the at least one processor 210 may provide, for training an AI model 460, sixth information 1040 on the seventh location sequence 1020 and seventh information 1050 on a location of the portion 1021-1 and 1021-2 of the first positions masked in the seventh location sequence 1020 to the AI model 460. For example, the seventh information 1030 may be described as information on an index (e.g., indices of masked places: 2,4) of the portion 1021-1 and 1021-2 of the first positions masked in the third location sequence 430.

For example, the at least one processor 210 may train the AI model 460 to identify that a sixth feature vector value 1072 representing a sixth path sequentially connecting positions included in the seventh location sequence 1020 and a first feature vector value 1071 are associated with each other based on the sixth information 1040 and the seventh information 1050.

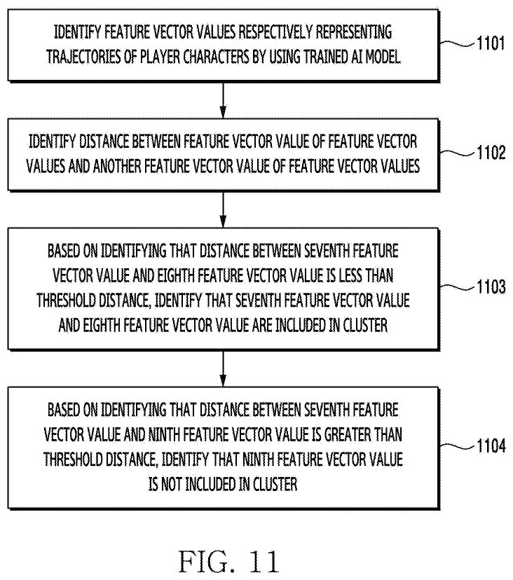

FIG. 11 is a flowchart illustrating an operation of identifying a cluster including feature vector values by using a trained AI model.

Referring to FIG. 11, in operation 1101, at least one processor 210 may identify feature vector values respectively representing trajectories of player characters by using a trained AI model 460. For example, the trained AI model 460 may be described as the AI model 460 trained by the operations and/or the methods described in FIGS. 3 to 10. For example, the trajectories may be described as daily trajectories of the player characters. For example, a dimension of the feature vector values may be set by a user.

In operation 1102, the at least one processor 210 may identify a distance between a feature vector value of the feature vector values and other feature vector values of the feature vector values. For example, the at least one processor 210 may project the feature vector value and the other feature vector values onto a vector space. The at least one processor 210 may identify a distance between the feature vector value and the other feature vector values projected onto the vector space.

In operation 1103, based on identifying that a distance between a seventh feature vector value of the feature vector values and an eighth feature vector value of the feature vector values is less than a threshold distance in accordance with identifying the distance, the at least one processor 210 may identify that the seventh feature vector value and the eighth feature vector value are included in a cluster.

In operation 1104, based on identifying that a distance between the seventh feature vector value and a ninth feature vector value of the feature vector values is greater than the threshold distance in accordance with identifying the distance, the at least one processor 210 may identify that the ninth feature vector value is not included in the cluster.

For example, the threshold distance may be set by a user. For example, the threshold distance may be determined in accordance with a size and/or a dimension of the vector space. For example, the cluster may include the seventh feature vector value to the ninth feature vector value. For example, the seventh feature vector value to the ninth feature vector value may include any one of the first feature vector value to the sixth feature vector value described above.

As described above, according to the operation described in FIG. 11, the at least one processor 210 may detect a bot user playing by using an automated program and/or an application program by identifying a cluster.

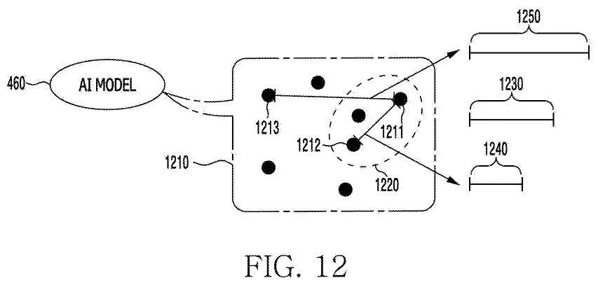

FIG. 12 illustrates a method of identifying a cluster including feature vector values by using a trained AI model.

Referring to FIG. 12, at least one processor 210 may identify feature vector values (e.g., a feature vector value 1211, a feature vector value 1212, and a feature vector value 1213) respectively representing trajectories of player characters by using a trained AI model 460. For example, the at least one processor 210 may project the feature vector values onto a vector space 1210. For example, a dimension of the vector space 1210 may be three or more dimensions. For example, the vector space 1210 having three or more dimensions may be represented in two dimensions through a dimensionality reduction algorithm. As an example, the dimensionality reduction algorithm may include principal component analysis (PCA) and/or t-distributed stochastic neighbor embedding (t-SNE).

For example, the at least one processor 210 may identify a distance between a feature vector value of the feature vector values and another feature vector value of the feature vector values. For example, the distance may be described as a distance between the feature vector value and the another feature vector value in the vector space 1210.

For example, the at least one processor 210 may identify that a distance 1240 between a seventh feature vector value 1211 of the feature vector values and an eighth feature vector value 1212 of the feature vector values is less than a threshold distance 1230 in accordance with identifying the distance. For example, the at least one processor 210 may identify that the seventh feature vector value 1211 and the eighth feature vector value 1212 are included in a cluster 1220 based on the identification.

For example, the at least one processor 210 may identify that a distance 1250 between the seventh feature vector value 1211 and a ninth feature vector value 1213 of the feature vector values is greater than the threshold distance 1230 in accordance with identifying the distance. For example, the at least one processor 210 may identify that the ninth feature vector value 1213 is not included in the cluster 1220 based on the identification.

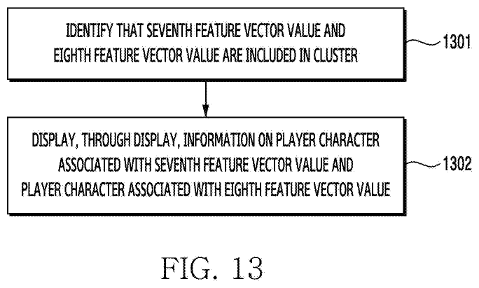

FIG. 13 is a flowchart illustrating an operation of displaying information on characters associated with feature vector values included in a cluster through a display.

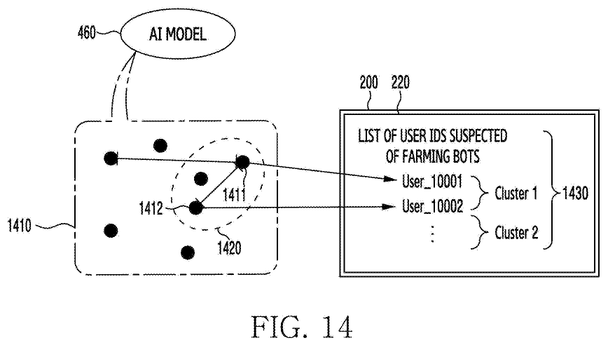

Referring to FIG. 13, in operation 1301, at least one processor 210 may identify that a seventh feature vector value (e.g., a seventh feature vector value 1411 of FIG. 14) and an eighth feature vector value (e.g., an eighth feature vector value 1412 of FIG. 14) are included in a cluster. The identification may correspond to the operation 1103 of FIG. 11. For example, the cluster may include the seventh feature vector value and the eighth feature vector value.

In operation 1302, the at least one processor 210 may display, through a display 220, information on a player character associated with the seventh feature vector value and a player character associated with the eighth feature vector value based on the identification. For example, the information on the player character associated with the seventh feature vector value and the information on the player character associated with the eighth feature vector value may include an identifier of the player character, a trajectory of the player character associated with the seventh feature vector value, and a trajectory of the player character associated with the eighth feature vector value.

For example, the at least one processor 210 may identify a plurality of clusters in accordance with identifying a distance between the feature vector values. Based on identifying the plurality of clusters, the at least one processor 210 may display, through the display 220, an identifier of the cluster including the seventh feature vector value and the eighth feature vector value to be linked with the information on the player character.

For example, the at least one processor 210 may display, through the display 220, the information on the player character associated with the seventh feature vector value and the player character associated with the eighth feature vector value on a webpage screen accessible to other users playing a game.

As described above, according to the operation described in FIG. 13, the at least one processor 210 may easily monitor player characters of a user suspected to be a bot user. The at least one processor 210 may share information on the player characters of the user suspected to be a bot user with other users through the webpage accessible to the other users playing the game.

FIG. 14 illustrates information on characters displayed through a display.

Referring to FIG. 14, at least one processor 210 may identify feature vector values (e.g., a feature vector value 1411 or a feature vector value 1412) representing trajectories of player characters by using an AI model 460. The at least one processor 210 may identify that the seventh feature vector value 1411 of the feature vector values and the eighth feature vector value 1412 of the feature vector values are included in a cluster 1420. For example, the seventh feature vector value 1411 may correspond to the seventh feature vector value 1211 of FIG. 12. For example, the eighth feature vector value 1412 may correspond to the eighth feature vector value 1212 of FIG. 12. For example, the cluster 1420 may be described as the cluster 1220 of FIG. 12.

For example, the at least one processor 210 may display, through a display 220, information 1430 on a player character associated with the seventh feature vector value 1411 and a player character associated with the eighth feature vector value 1412 based on identifying the cluster. For example, the at least one processor 210 may display, through the display 220, an identifier (e.g., Cluster 1) of the cluster 1420 to be linked with the information 1430 on the player character.

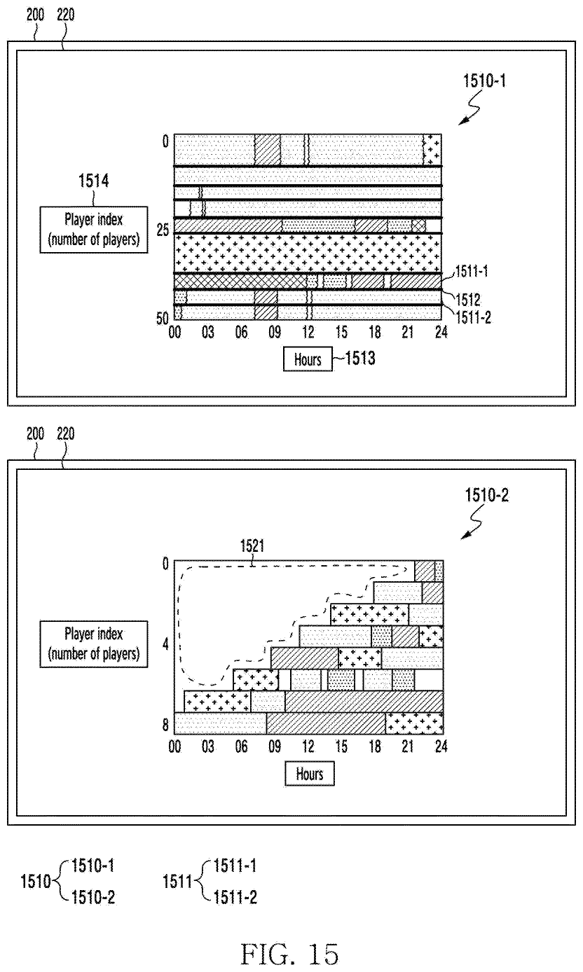

FIG. 15 illustrates a map representing a positional relationship between feature vector values through a display.

Referring to FIG. 15, at least one processor 210 may identify a distance between feature vector values representing trajectories of player characters. The at least one processor 210 may identify the distance between the feature vector values based on the identification. The at least one processor 210 may identify a cluster based on identifying that a distance between a feature vector value of the feature vector values and another feature vector value of the feature vector values is less than a threshold distance. For example, the at least one processor 210 may identify one or more clusters.

For example, the at least one processor 210 may display maps 1510 representing the positional relationship between the feature vector values through a display 220. For example, the maps 1510 may include a map 1510-1 representing a positional relationship between feature vector values included in a plurality of clusters, and a map 1510-2 representing a positional relationship between feature vector values not included in the cluster.

For example, within the map 1510-1, a cluster 1511-1 may be visually distinguished from another cluster 1511-2. For example, the at least one processor 210 may display, through the display 220, a visual object 1512 distinguishing the cluster 1511-1 and the another cluster 1511-2. As an example, the visual object 1512 may be an object having a line shape.

For example, the at least one processor 210 may display, through the display 220, trajectories of player characters associated with each of feature vectors within the map. For example, a coordinate of the map may include timing data 1513 and an index 1514 of a player character. The timing data may be described as a time at which the player character is located at a position.

For example, the at least one processor 210 may represent a color of a coordinate displayed through the display 220 within the maps 1510 by a combination of red, green, and blue. The at least one processor 210 may determine a weight of each of the red, the green, and the blue in accordance with information on a position at which the player character is located. For example, a weight of the red may be determined in accordance with an identifier corresponding to an area in which the player character is located. For example, a weight of the green may be determined in accordance with a coordinate value corresponding to a horizontal axis of a coordinate at which the player character is located. For example, a weight of the blue may be determined in accordance with a coordinate value corresponding to a vertical axis of the coordinate at which the player character is located.

According to an embodiment, a position of a player character may be represented by a three-dimensional coordinate. For example, the three-dimensional coordinate may include a coordinate value corresponding to a height axis of the coordinate at which the player character is located, the coordinate value corresponding to the horizontal axis, and the coordinate value corresponding to the vertical axis. For example, the weight of the red may be determined in accordance with the coordinate value corresponding to the height axis of the coordinate at which the player character is located. For example, the weight of the green may be determined in accordance with the coordinate value corresponding to the horizontal axis of the coordinate at which the player character is located. For example, the weight of the blue may be determined in accordance with the coordinate value corresponding to the vertical axis of the coordinate at which the player character is located. For example, an area 1521 corresponding to a time at which the player character accesses may be displayed in white through the display 220. The white may be displayed through the display 220 by setting the weight of the red, the weight of the green, and the weight of the blue all to 0.

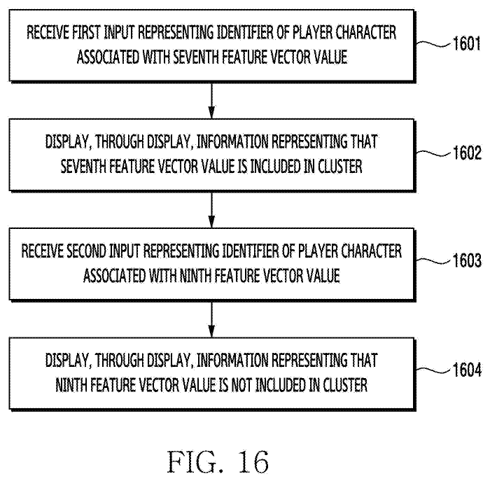

FIG. 16 is a flowchart illustrating an operation of identifying whether a character is included in a cluster based on an input representing an identifier of the character.

Referring to FIG. 16, in operation 1601, at least one processor 210 may receive a first input representing an identifier of a player character associated with a seventh feature vector value (e.g., the seventh feature vector value 1411 of FIG. 14). For example, the first input may include a user input. For example, the at least one processor 210 may receive a text input representing the identifier of the player character associated with the seventh feature vector value, and an input activating searching for the player character based on the text input.

In operation 1602, the at least one processor 210 may display, through the display 220, information representing that the seventh feature vector value is included in a cluster (e.g., the cluster 1420 of FIG. 14) based on the first input. For example, the at least one processor 210 may display, through the display 220, a visual object representing a trajectory of the player character associated with the seventh feature vector value to be linked with the information representing that the seventh feature vector value is included in the cluster. For example, the at least one processor 210 may display, through the display 220, information representing an identifier of at least one player character associated with another feature vector value (e.g., the eighth feature vector value 1412 of FIG. 14) included in the cluster including the seventh feature vector value to be linked with the information representing that the seventh feature vector value is included in the cluster.

In operation 1603, the at least one processor 210 may receive a second input representing an identifier of a player character associated with a ninth feature vector value (e.g., the ninth feature vector value 1213 of FIG. 12). The operation of receiving the second input may correspond to the operation of receiving the first input in the operation 1601.

In operation 1604, the at least one processor 210 may display, through the display 220, information representing that the ninth feature vector value is not included in the cluster based on the second input. For example, the at least one processor 210 may display, through the display 220, a visual object representing a trajectory of the player character associated with the ninth feature vector value to be linked with the information representing that the ninth feature vector value is not included in the cluster. For example, the at least one processor 210 may display, through the display 220, based on identifying a distance between the ninth feature vector value and the seventh feature vector value, information on an exposure frequency of the player character associated with the ninth feature vector value to the player character associated with the seventh feature vector value, to be linked with the information representing that the ninth feature vector value is not included in the cluster.

As described above, according to the operation described in FIG. 16, the at least one processor 210 may identify whether a specific player character corresponds to a bot user. The at least one processor 210 may identify another player character included in a cluster including the specific player character. The at least one processor 210 may identify information on an exposure frequency of the specific player character to another player character corresponding to the bot user.

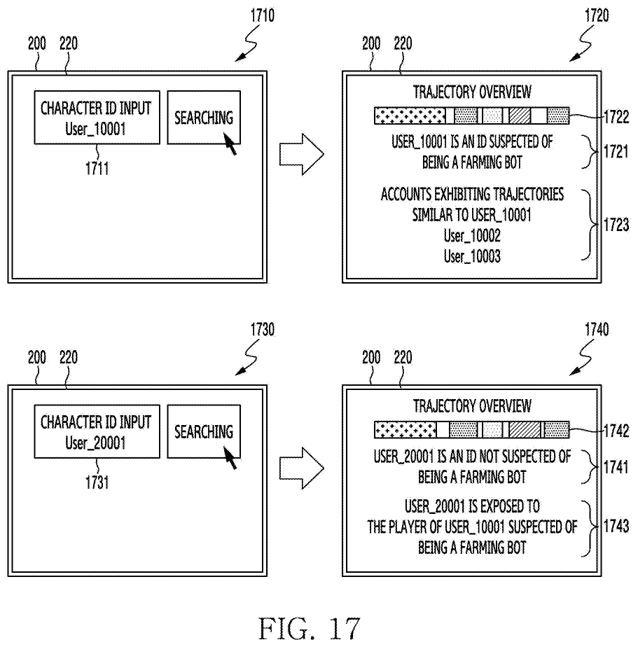

FIG. 17 illustrates a method of displaying information representing whether a character is included in a cluster based on an input representing an identifier of the character.

Referring to FIG. 17, at least one processor 210 may receive a first input representing an identifier 1711 of a player character associated with a seventh feature vector value. The at least one processor 210 may change a state of an electronic device 200 from a state 1710 to a state 1720 in response to receiving the first input.

In the state 1720, the at least one processor 210 may display, through a display 220, information 1721 representing that the seventh feature vector value is included in a cluster based on the first input. For example, the at least one processor 210 may display, through the display 220, a visual object 1722 representing a trajectory of the player character associated with the seventh feature vector value to be linked with the information 1721 representing that the seventh feature vector value is included in the cluster. For example, the at least one processor 210 may display, through the display 220, information 1723 representing an identifier of at least one player character associated with another feature vector value included in the cluster including the seventh feature vector value to be linked with the information 1721 representing that the seventh feature vector value is included in the cluster.

For example, the at least one processor 210 may receive a second input representing an identifier 1731 of a player character associated with a ninth feature vector value. The at least one processor 210 may change a state of the electronic device 200 from a state 1730 to a state 1740 in response to receiving the second input.

In the state 1740, the at least one processor 210 may display, through the display 220, information 1741 representing that the ninth feature vector value is not included in the cluster based on the second input. For example, the at least one processor 210 may display, through the display 220, a visual object 1742 representing a trajectory of the player character associated with the ninth feature vector value to be linked with the information 1741. For example, the at least one processor 210 may display, through the display 220, based on identifying a distance between the ninth feature vector value and the seventh feature vector value, information 1743 on an exposure frequency of the player character associated with the ninth feature vector value to the player character associated with the seventh feature vector value to be linked with the information 1741.

According to an embodiment, the at least one processor 210 may identify a player character using an automated program within massively multiplayer online role-playing games (MMORPGs). For example, the at least one processor 210 may identify bot users in which the player characters have similar trajectories and behave collectively. The at least one processor 210 may train an AI model 460 for identifying the player characters as a cluster. The at least one processor 210 may train the AI model 460 such that the AI model 460 identifies that feature vector values corresponding to player characters having contextually similar trajectories are close to each other. The at least one processor 210 may identify the bot users using density-based spatial clustering of applications with noise (DBSCAN).

For example, the at least one processor 210 may identify that behaviors of player characters have various patterns similar to a pattern within the real world. The at least one processor 210 may identify that at least one group including player characters exhibits abnormal gaming efficiency using the automated program. The at least one processor 210 may identify the player characters as the bot users. The at least one processor 210 may identify that a behavior pattern of the player characters behaving collectively is different from a behavior pattern within the real world due to at least one reason among purchasing of a potion, strategic hunting, teleportation, and/or resurrection after death. The at least one processor 210 may identify whether it corresponds to bot users by identifying a feature vector value representing a trajectory of player characters without data labeling.

For example, the at least one processor 210 may not identify character players associated with two trajectories that are generally similar, as the bot users. For example, the at least one processor 210 may identify the player characters as the bot users based on identifying trajectories of player characters exhibiting sporadic behaviors due to a reason including purchasing of a potion and/or resurrection after death.

For example, the at least one processor 210 may generate a game environment based on a local coordinate system rather than a global positioning system (GPS) coordinate system. For example, the local coordinate system may not be used together with the GPS coordinate system. A description regarding the local coordinate system will be described later. The at least one processor 210 may identify a feature vector value representing a trajectory of a player character. The at least one processor 210 may efficiently train the AI model 460 for a long sequence.

For example, the player characters may use teleportation to visit a hunting ground and a village. The hunting ground and the village are far away within a game environment. The at least one processor 210 may identify that the hunting ground and the village are contextually close in a context of an actual behavior of a player character. The at least one processor 210 may identify that a feature vector value representing a trajectory of a player character located only in an area corresponding to the hunting ground and a feature vector value representing a trajectory of a player character located in the area corresponding to the hunting ground and sporadically located in an area corresponding to the village are close.

For example, the at least one processor 210 may identify whether a player character corresponds to a bot user based on information on a trajectory of the player character. For example, the at least one processor 210 may provide game masters with explainable data on an estimation that the player character corresponds to the bot user. For example, the game masters may explain to game users whether the player character corresponds to the bot user using only the information on the trajectory of the player character.

For example, the at least one processor 210 may obtain information on positions of player characters based on a time period. For example, the at least one processor 210 may obtain information on a position of a player character to be linked with time. For example, the at least one processor 210 may obtain information on a position of a player character every minute. For example, the at least one processor 210 may obtain information on a daily trajectory of the player character based on obtaining the information on the position of the player character every minute. For example, the at least one processor 210 may identify a location sequence including positions within the game environment, through which the player character moves sequentially. As an example, the location sequence may be information on a portion of the daily trajectory of the player character. For example, the at least one processor 210 may provide, for training the AI model 460, the information on the location sequence to the AI model 460.

For example, the at least one processor 210 may identify a third position and a fourth position consecutive within the location sequence provided to the AI model. For example, the at least one processor 210 may omit the third position or the fourth position within the location sequence based on identifying that the third position and the fourth position are represented by an identifier corresponding to the same area and the same coordinate. The at least one processor 210 may identify information on more various positions from the location sequence by omitting the third position or the fourth position.

For example, the at least one processor 210 may generate a location sequence of a length of 16 provided to train the AI model 460. For example, the at least one processor 210 may generate the location sequence of the length of 16 by dividing a location sequence of a length of 32 based on generating the location sequence of the length of 32. For example, the at least one processor 210 may generate an anchor, a positive sample, and a negative sample. Each of the anchor, the positive sample, and the negative sample may correspond to the location sequence of the length of 16. For example, the location sequence of the length of 32 may be described as the first location sequence 410 of FIG. 4. For example, the anchor may be described as the third location sequence 430 of FIG. 4. For example, the positive sample may be described as the fourth location sequence 440 of FIG. 4. For example, the negative sample may be described as the second location sequence 420 of FIG. 4. A method of generating the anchor, the positive sample, and the negative sample will be described later.

For example, the at least one processor 210 may represent each of positions included in the location sequence by an identifier corresponding to an area and a coordinate. For example, a position may be included in the area. For example, the coordinate may be a coordinate of each of positions defined for the area. For example, positions through which the player character visits sequentially may be represented by the following equation.

$${L}^{\text{?}} = \{ ( {l}_{1}^{( x )} , {l}_{1}^{( y )} , {l}_{1}^{( c )} ) , ( {l}_{2}^{( x )} , {l}_{2}^{( y )} , {l}_{2}^{( c )} ) , … , ( {l}_{\text{?}}^{( x )} , {l}_{\text{?}}^{( y )} , {l}_{\text{?}}^{( c )} ) \} = \{ {l}_{1} , {l}_{2} , … , {l}_{\text{?}} \} \qquad [ Equation 1 ]$$

$$\text{?} \text{indicates text missing or illegible when filed}$$

Referring to the Equation 1, L^{p}^{₁} the represents a location sequence of a player character 1. The

$${l}_{1}^{( x )}$$

represents a coordinate value of a horizontal axis of a position included in the location sequence. The

$${l}_{1}^{( y )}$$

represents a coordinate value of a vertical axis of a position included in the location sequence. The

$${l}_{1}^{( c )}$$

represents an identifier corresponding to an area including a position included in the location sequence.

For example, the at least one processor 210 may identify the positions as an identifier for an area, a coordinate corresponding to a zone, and a coordinate corresponding to a cell according to the method described with reference to FIG. 5. For example, a method of identifying the positions as an identifier for an area, a coordinate corresponding to a zone, and a coordinate corresponding to a cell may be represented by the following equations.

$$z ( {l}_{i}^{′} ) = ( ⌊ {l}_{i}^{′ ( x )} / 256 ⌋ , ⌊ {l}_{i}^{′ ( y )} / 256 ⌋ , {l}_{i}^{′ ( c )} ) \qquad [ Equation 2 ]$$

$$c ( {l}_{i}^{′} ) = ( \vert {l}_{i}^{′ ( x )} / 8 \vert , \vert {l}_{i}^{′ ( y )} / 8 \vert , {l}_{i}^{′ ( c )} ) \qquad [ Equation 3 ]$$

Referring to the Equation 2, the

$$z ( {l}_{i}^{′} )$$

represents a coordinate corresponding to a zone. The coordinate corresponding to the zone represents only an integer portion obtained by discarding a fractional portion of a value obtained by dividing the

$${l}_{i}^{′ ( x )}$$

and the

$${l}_{i}^{′ ( y )}$$

### by 256. Referring to Equation 3, the

$$c ( {l}_{i}^{′} )$$

represents a coordinate corresponding to a cell. The coordinate corresponding to the cell represents only an integer portion obtained by discarding a fractional portion of a value obtained by dividing the

$${l}_{i}^{′ ( x )}$$

and the

$${l}_{i}^{′ ( y )}$$

by 8. For example, an area corresponding to a plurality of coordinates corresponding to cells may be included in an area corresponding to a coordinate corresponding to the zone.

For example, the at least one processor 210 may solve an out of vocabulary (OOV) problem by representing positions included in the location sequence as a coordinate corresponding to a zone and a coordinate corresponding to a cell. The OOV problem may occur when the AI model is provided with new data not included in training data. For example, the at least one processor 210 may compress information on a position by using the coordinate corresponding to the zone and the coordinate corresponding to the cell. For example, the at least one processor 210 may solve the OOV problem by compressing the information on the position.

For example, the at least one processor 210 may generate an anchor and a positive sample by dividing the location sequence including the positions through which the player character moves sequentially. For example, the at least one processor 210 may divide the location sequence by separating odd-numbered positions and even-numbered positions. A method of obtaining the anchor and the positive sample by separating the odd-numbered positions and the even-numbered positions and a method of obtaining a negative sample may be represented by the following equations.

$${𝒜}_{k}^{( o )} = \{ {s}_{i} ∈ {msk}_{r}^{δ} ( {d}_{k}^{prep} ) \vert i = 1 , 3 , … , 31 \} \qquad [ Equation 3 ]$$

$${𝒫}_{k}^{( o )} = \{ {s}_{i} ∈ {d}_{k}^{prep} \vert i = 2 , 4 , … , 32 \} \qquad [ Equation 3 ]$$

$${𝒩}_{k}^{( o )} = {𝒫}_{\begin{matrix}{k}^{′} \\ k \neq {k}^{′}\end{matrix}}^{( o )} where {k}^{′} ∼ U ( 1 , M ) \qquad [ Equation 3 ]$$

Referring to the Equation 4, the M represents the number of training data sets. The

$${𝒜}_{k}^{( o )}$$

represents an anchor. The

$${d}_{k}^{prep}$$

represents an identifier for an area representing positions within the game environment, through which a player character moves sequentially, a coordinate corresponding to a zone, and a coordinate corresponding to a cell. The

$${msk}_{r}^{δ}$$

represents a function masking a portion of the positions included in the location sequence in accordance with a probability of r that may be set by a user of the electronic device 200. The δ represents index information of some masked positions among positions included in the anchor. Referring to the Equation 5, the

$${𝒫}_{k}^{( o )}$$

represents a positive sample. Referring to the Equation 6, the

$${𝒩}_{k}^{( o )}$$

represents a negative sample. The negative sample is generated based on training data different from the anchor and the positive sample.

For example, the at least one processor 210 may generate an anchor and a positive sample by dividing a location sequence including positions through which the player character moves sequentially. For example, the at least one processor 210 may divide the location sequence by dividing it into a first portion and a second portion of the location sequence. An initial position included in the first portion may be identical to an initial position included in the location sequence. A last position included in the first portion may be continuous with an initial position included in the second portion in the location sequence. A last position included in the second portion may be identical to a last position in the location sequence. As an example, the number of positions included in the first portion and the number of positions included in the second portion may be identical or may differ by one. As an example, the at least one processor 210 may identify the anchor as the first portion. The at least one processor 210 may identify the positive sample as the second portion. A method of dividing the location sequence into the first portion and the second portion may be represented as the following equation.

$${𝒜}_{k}^{( h )} = \{ {s}_{i} ∈ {msk}_{r}^{δ} ( {d}_{k}^{prep} ) \vert i = 1 , … , 16 \} \qquad [ Equation 7 ]$$

$${𝒫}_{k}^{( h )} = \{ {s}_{i} ∈ {d}_{k}^{prep} ) \vert i = 17 , … , 32 \} \qquad [ Equation 8 ]$$

$${𝒩}_{k}^{( h )} = {𝒫}_{{{k}^{′}}_{k \neq {k}^{′}}}^{( h )} where {k}^{′} \sim U ( 1 , M ) \qquad [ Equation 9 ]$$

Referring to the Equation 7, the

$${𝒜}_{k}^{( h )}$$

represents a first portion described as an anchor. Referring to the Equation 8, the

$${𝒫}_{k}^{( h )}$$

represents a second portion described as a positive sample. Referring to the Equation 9, the

$${𝒩}_{k}^{( h )}$$

represents a negative sample. The equations included in the Equation 7, the Equation 8, and the Equation 9 may correspond to the equations included in the Equation 4, the Equation 5, and the Equation 6.

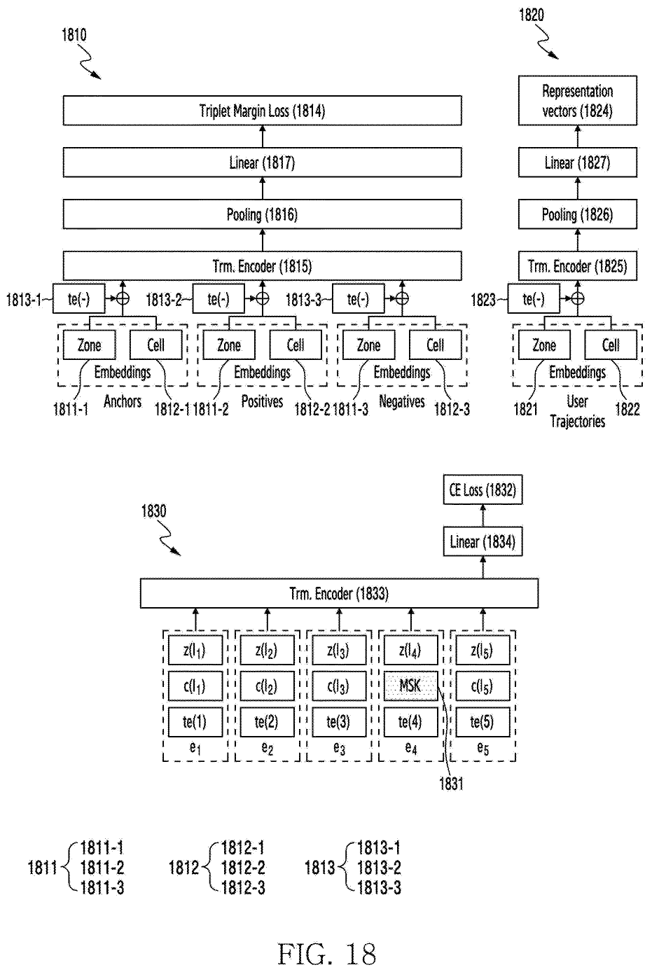

FIG. 18 illustrates a method of training an AI model by using contrastive learning and masked cell prediction (MCP).

Referring to FIG. 18, at least one processor 210 may train an AI model 460 by using contrastive learning 1810 and MCP 1830. For example, information 1811 on a zone may include a coordinate corresponding to the zone and an identifier corresponding to an area including the zone. For example, information 1812 on a cell may include a coordinate corresponding to the cell and an identifier corresponding to an area including the cell. The at least one processor 210 may convert the information 1811 on the zone and the information 1812 on the cell into an embedding vector through an embedding module. The embedding module may be represented as the following equation.

eⱼ=e_{z}(sⱼ)+±e_{c}(sⱼ)+te(t+j) [Equation 10]

Referring to the Equation 10, the sⱼ represents information on a position included in a location sequence. The e_{z}(⋅) represents a module converting information on a zone into an embedding vector. The e_{c}(⋅) represents a module converting information on a cell into an embedding vector. The te(⋅) represents a function for timestamp encoding. For example, data provided by the te(⋅) may correspond to the first timing data, the second timing data, and the third timing data described with reference to FIG. 6.

For example, data provided by a function 1813-1 for timestamp encoding may correspond to the first timing data described with reference to FIG. 6. For example, data provided by a function 1813-2 for timestamp encoding may correspond to the second timing data described with reference to FIG. 6. For example, data provided by a function 1813-3 for timestamp encoding may correspond to the third timing data described with reference to FIG. 6.

The j represents an index of the position included in the location sequence. The index may represent information on an order of the position in the location sequence. Based on a length of the location sequence being 16, the index may have a value from 1 to 16. The eⱼ represents a value obtained by adding a timestamp encoding value to a vector value embedding a coordinate corresponding to a zone, a coordinate corresponding to a cell, and an identifier corresponding to an area. For example, the embedding module may generate an embedding vector by considering a relationship between the coordinate corresponding to the zone, the coordinate corresponding to the cell, and the identifier corresponding to the area.

For example, the location sequence of a length of 16 is associated with an embedding matrix. The embedding matrix may be represented as the following equation.

Eᵢ=(e₁, . . . ,eⱼ. . . ,e₁₆) [Equation 11]

Referring to the Equation 11, the Eᵢ represents an embedding matrix of values obtained by adding a timestamp encoding value to each of vector values embedding information on positions included in the location sequence. For example, the

$${E}_{i}^{𝒜}$$

represents an embedding matrix of an anchor. For example, the

$${E}_{i}^{𝒫}$$

represents an embedding matrix of a positive sample. For example, the

$${E}_{i}^{𝒩}$$

represents an embedding matrix of a negative sample.

For example, the at least one processor 210 may provide the embedding matrix of the anchor, the embedding matrix of the positive sample, and the embedding matrix of the negative sample to a transformer encoding layer 1815. For example, the transformer encoding layer 1815 may be defined to perform a transformer encoding operation. For example, a transformer encoding method may be represented as the following equation.

$${F}_{i}^{𝒜} = trm ( {E}_{i}^{𝒜} ) \qquad [ Equation 12 ]$$

Referring to the Equation 12, the trm(⋅) represents a function performing the transformer encoding operation.

For example, the at least one processor 210 may identify a relationship between positions included in the location sequence using the transformer encoding function. For example, the at least one processor 210 may identify a high-dimensional feature including a context in which the player character moves from the hunting ground to the village and/or a context in which the player character moves from the village to the hunting ground using the transformer encoding function. For example, the at least one processor 210 may provide the

$${F}_{i}^{𝒜}$$

to a pooling layer 1816. For example, the pooling layer 1816 may be defined to perform a pooling operation. As an example, the pooling operation may include an average pooling operation. As an example, the pooling layer 1816 may generate a pooled vector. The pooling layer 1816 may provide the pooled vector to a linear layer 1817. For example, the linear layer 1817 may be defined to perform a linear operation. Although a method of performing transformer encoding only for an anchor has been described, it may also be applied to a method of performing transformer encoding for a positive sample and a negative sample. A method by which the linear layer 1817 obtaining the pooled vector calculates a first loss value may be represented as the following equations.

$$Linear ( x ) = {xW}^{T} + b \cdot {ℛ}_{i}^{𝒜} \qquad [ Equation 13 ]$$

$${ℛ}_{i}^{𝒜} = Linear ( Pooling ( {F}_{i}^{𝒜} ) ) \qquad [ Equation 14 ]$$

$${ℒ}_{1} ( {ℛ}_{i}^{𝒜} , {ℛ}_{i}^{𝒫} , {ℛ}_{i}^{𝒩} ) = {[ {‖ {ℛ}_{i}^{𝒜} - {ℛ}_{i}^{𝒫} ‖}_{2}^{2} - {‖ {ℛ}_{i}^{𝒜} - {ℛ}_{i}^{𝒩} ‖}_{2}^{2} + β ]}_{+} \qquad [ Equation 15 ]$$

Referring to the Equation 13, the W^{T} and the b represent parameters adjusted in accordance with progress of training of the AI model 460. The Linear(⋅) represents a linear function.

Referring to the Equation 14, the

$${ℛ}_{i}^{𝒜}$$

represents a vector obtained by converting

$${F}_{i}^{𝒜}$$

derived from the transformer encoding function through a pooling function and a linear function.

Referring to the Equation 15, the L(⋅) represents a function calculating the first loss value 1814. The

$${‖ {ℛ}_{i}^{A} - {ℛ}_{i}^{𝒫} ‖}_{2}^{2}$$

represents a distance between a vector value corresponding to an anchor and a vector value corresponding to a positive sample. The

$${‖ {ℛ}_{i}^{A} - {ℛ}_{i}^{𝒩} ‖}_{2}^{2}$$

represents a distance between a vector value corresponding to an anchor and a vector value corresponding to a negative sample. For example, the at least one processor 210 may calculate the distance between the vector values using a method of Euclidean norm. The β represents a parameter associated with the first loss value 1814 and adjustable in accordance with the progress of the training of the AI model 460. The [⋅]₊ represents a function returning a value in the bracket as it is when a value in the bracket is greater than 0 and returning a value of 0 when a value in the bracket is less than 0. For example, the at least one processor 210 may identify the first loss value 1814 using a first loss value calculation model 1810.

For example, the at least one processor 210 may mask a portion of positions included in a location sequence before training the AI model 460. As an example, the at least one processor 210 may mask a portion of positions included in a location sequence corresponding to an anchor. As an example, the at least one processor 210 may mask a coordinate (e.g., the coordinate 1022-1 or 1022-2 corresponding to the cell of FIG. 10) corresponding to a cell representing the portion of the positions based on masking the portion of the positions.

For example, a transformer encoding layer 1833 may be defined to perform a transformer encoding operation. For example, a linear layer 1834 may be defined to perform a linear operation. The at least one processor 210 may identify a vector value corresponding to a location sequence using the transformer encoding layer 1833 and the linear layer 1834. The at least one processor 210 may identify a vector value corresponding to a location sequence in which the portion of the positions are masked (e.g., ŷⱼ the of the Equation 16) and a vector value corresponding to a location sequence before the portion of the positions are masked (e.g., the yⱼ of the Equation 17). The at least one processor 210 may identify a second loss value 1832 based on identifying the vector values. A method of identifying a vector value corresponding to the location sequence in which the portion of the positions are masked may be represented as the following equation.

$${\hat{y}}_{j} = Linear ( {f}_{j}^{𝒜} ) for each {f}_{j}^{𝒜} ∈ {F}_{i}^{𝒜} , where j ∈ δ \qquad [ Equation 16 ]$$

Referring to the Equation 16, the

$${F}_{i}^{𝒜}$$

represents a vector matrix obtained by transformer encoding a vector in which the location sequence corresponding to the anchor is embedded. The δ represents information on an index in the location sequence of the masked portion of the positions. The

$${f}_{j}^{𝒜}$$

represents a vector included in the vector matrix obtained by transformer encoding the embedded vector and corresponding to the masked portion of the positions. The j represents an index within the location sequence of the masked portion of the positions in the location sequence. The ŷⱼ represents a value derived by providing the

$${f}_{j}^{𝒜}$$

to a linear function. For example, the second loss value 1832 associated with the ŷⱼ may be represented as the following equation.

$${ℒ}_{2} ( {y}_{j} , {\hat{y}}_{j} ) = - {\sum }_{k = 1}^{C} {y}_{j , k} log ( {\hat{y}}_{j , k} ) \qquad [ Equation 17 ]$$

Referring to the Equation 17, the [symbol] ₂(⋅) represents a function calculating the second loss value (e.g., cross entropy loss) 1832. The C represents the number of classes to be classified. The k represents an index for each of classes within a range from 1 to C. The j represents an index in the location sequence of the masked portion of the positions. The y_{j,k} represents a value generated as information on a location sequence before the portion of the positions are masked performs a transformer encoding operation and a linear operation after the transformer encoding operation. For example, the second loss value may represent a cross entropy loss value. The cross entropy loss value may be a value representing a difference between a predicted probability distribution of the AI model 460 and an actual answer distribution. The at least one processor 210 may train the AI model 460 such that the AI model 460 accurately predicts the masked portion of the positions using the cross entropy loss value. For example, the at least one processor 210 may train the AI model 460 such that the AI model 460 accurately predicts the masked portion of the positions using a second loss value calculation model 1830.

For example, the at least one processor 210 may identify the first loss value (e.g., triplet margin loss) 1814 associated with the contrastive learning 1810 and the second loss value (e.g., cross entropy loss) 1832 associated with the MCP 1830. For example, the at least one processor 210 may reduce a total loss value obtained by adding the second loss value 1832 associated with the MCP 1830 to the first loss value 1814 in accordance with the progress of the training of the AI model 460. The total loss value may be represented as the following equation.

[symbol]

= [symbol] ₁+ [symbol] ₂ [Equation 18]

Referring to the Equation 18, the [symbol] represents the total loss value. The at least one processor 210 may perform a backpropagation operation using the total loss value. For example, the at least one processor 210 may train the AI model 460 by adjusting a plurality of parameters indicating the AI model 460 through the backpropagation operation.

For example, the at least one processor 210 may identify a feature vector value 1824 for a trajectory of a player character using the trained AI model 460. For example, the at least one processor 210 may identify the feature vector value 1824 for the trajectory of the player character using a feature vector value calculation model 1820. The at least one processor 210 may embed information on positions within the game environment, through which the player character moves sequentially, through an embedding module. For example, the information on the position may include an identifier corresponding to an area, a coordinate corresponding to a zone, and a coordinate corresponding to a cell. The at least one processor 210 may provide information on embedded positions and a timestamp encoding value 1823 to a transformer encoding layer 1825.

For example, the timestamp encoding value 1823 is described as actual timing data for the trajectory of the player character, unlike the first timing data and the third timing data randomly determined in the reference range described with reference to FIG. 6. As an example, based on that information on a position of a player character is obtained at a period of 1 minute, the timestamp encoding value 1823 may be determined from 1 to 1440 in accordance with indices of the positions included in the location sequence. As an example, based on that a length of a location sequence corresponding to the trajectory of the player character is 1440, for a 1001st position in the location sequence, the timestamp encoding value 1823 may be determined as 1001.

The transformer encoding layer 1825 may be defined to perform a transformer encoding operation. The transformer encoding layer 1825 obtaining the information on the embedded positions may provide the transformer encoded information to a pooling layer 1826. The pooling layer may be defined to perform a pooling operation. The pooling layer 1826 obtaining the transformer encoded information may provide pooled information to a linear layer 1827. The linear layer 1827 may be defined to perform a linear operation. The at least one processor 210 may identify the feature vector value 1824 using the linear layer 1827 obtaining the pooled information.

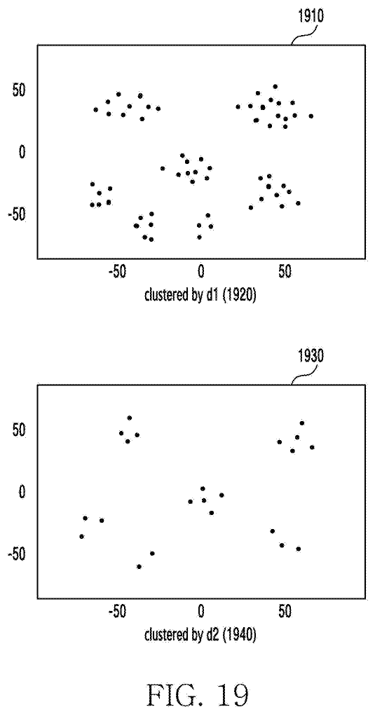

FIG. 19 illustrates an example of clusters identified based on feature vector values.

Referring to FIG. 19, at least one processor 210 may project feature vector values obtained using an AI model 460 onto a vector space (e.g., a vector space 1910 or a vector space 1930). For example, the vector space may have three or more dimensions. For example, the at least one processor 210 may represent feature vectors projected onto the vector space having three or more dimensions on a two-dimensional space (e.g., the vector space 1910 or the vector space 1930) using a principal component analysis (PCA) and/or a t-distributed stochastic neighbor embedding (t-SNE) algorithm.

For example, the at least one processor 210 may identify a cluster including the feature vectors using a density-based spatial clustering of applications with noise (DBSCAN) algorithm. For example, the DBSCAN algorithm may be indicated by a first parameter corresponding to the number of minimum vectors and a second parameter corresponding to a threshold distance (e.g., a first threshold distance 1920 or a second threshold distance 1940). As an example, the at least one processor 210 may adjust the first parameter and the second parameter. As an example, the second parameter may be determined in accordance with a size of the vector space.

For example, the first threshold distance 1920 may be longer than the second threshold distance 1940. The at least one processor 210 may identify more clusters and more feature vector values included in the clusters in the vector space 1910 associated with the first threshold distance 1920 than in the vector space 1930 associated with the second threshold distance 1940, based on identifying that the first threshold distance 1920 is longer than the second threshold distance 1940.

For example, the first parameter may be set to 4. The at least one processor 210 may identify four or more feature vector values located within the threshold distance as the cluster, based on identifying that the four or more feature vector values within the vector space (e.g., the vector space 1910 or the vector space 1930) are located within the threshold distance.

For example, the at least one processor 210 may identify feature vector values as one cluster using a specified algorithm (e.g., a K-means algorithm). The at least one processor 210 may identify K cluster centers on the vector space. The at least one processor 210 may identify a distance from each of the cluster centers to each of the feature vector values. The at least one processor 210 may connect a feature vector value to the closest cluster center based on the distance.

For example, the at least one processor 210 may train the AI model 460 by adjusting a plurality of parameters. The plurality of parameters associated with the trained AI model 460 may be described with reference to the following table.

TABLE 1

| Exp | Model params. | | | | | clustering | Detecting | Contextual | | Acc |
|---|---|---|---|---|---|---|---|---|---|---|
| types | d_model | d_hid | β | zone | MCP | [symbol] quant. (q) | count | pos | neg | Info |
| [symbol] | 256 | 1024 | 0.5 | True | 0.2 | 0.05 | 928 | 0.3625 | 0.0005 | 1.0079 |
| (a) | 256 | 1024 | 0.5 | True | 0.3 | 0.05 | 921 | 0.3596 | 0.0005 | 1.0444 |
| | 256 | 1024 | 1.0 | True | 0.2 | 0.05 | 976 | 0.3552 | 0.0003 | 1.0079 |
| | 512 | 2048 | 0.5 | True | 0.2 | 0.05 | 963 | 0.3560 | 0.0003 | 1.0697 |
| (b) | 256 | 1024 | 0.5 | True | 0.0 | 0.05 | 918 | 0.3208 | 0.0006 | 1.0767 |
| | 256 | 1024 | 0.5 | False | 0.2 | 0.05 | 917 | 0.3472 | 0.0005 | 1.0551 |
| | 256 | 1024 | 0.5 | False | 0.0 | 0.05 | 930 | 0.3183 | 0.0006 | 1.1307 |
| (c) | 256 | 1024 | 0.5 | True | 0.2 | 0.10 | 1932 | 0.3203 | 0.0006 | 1.0787 |
| | 256 | 1024 | 0.5 | True | 0.2 | 0.15 | 3031 | 0.2931 | 0.0006 | 1.1094 |
| | 256 | 1024 | 0.5 | True | 0.2 | 0.20 | 4109 | 0.2732 | 0.0006 | 1.1363 |

[symbol]

indicates data missing or illegible when filed

The Table 1 is described as a table evaluating performance of the AI model 460 in accordance with adjusting parameters in accordance with the AI model 460. Referring to the Table 1, the d_model represents the number of dimensions of a feature vector value identified by the AI model 460. The d_hid represents the number of dimensions of an inner layer (e.g., a transformer encoding layer, a linear layer, or a pooling layer). For example, the d_hid may be determined based on the d_model. The β represents a parameter associated with a first loss value 1814 and adjustable in accordance with progress of training of the AI model 460. The zone is a parameter that may be set to True or False. The at least one processor 210 provides information on a zone (e.g., a coordinate corresponding to the zone) to the AI model 460 based on identifying that zone is set to True. The at least one processor 210 does not provide the information on the zone to the AI model 460 based on identifying that zone is set to False. The MCP represents a probability of masking positions included in the location sequence. The q represents the threshold distance (e.g., the threshold distance 1920 of FIG. 19 or the threshold distance 1940 of FIG. 19) that is the second parameter associated with the DBSCAN algorithm.

According to an embodiment, an electronic device is provided. The electronic device may comprise at least one processor including processing circuitry. The electronic device may comprise memory comprising one or more storage media storing instructions. The instructions, when executed by the at least one processor individually or collectively, may cause the electronic device to identify a first location sequence including positions within a game environment, through which a first player character moves sequentially. The instructions, when executed by the at least one processor individually or collectively, may cause the electronic device to identify a second location sequence including positions within a game environment through which a second player character different from the first player character moves sequentially. The instructions, when executed by the at least one processor individually or collectively, may cause the electronic device to, by dividing the first location sequence, obtain a third location sequence including first positions from among the positions included in the first location sequence, and a fourth location sequence including second positions from among the positions included in the first location sequence. The first positions and the second positions may be determined alternately. The instructions, when executed by the at least one processor individually or collectively, may cause the electronic device to provide, for training an artificial intelligence (AI) model to be used to identify a feature vector value for a trajectory of a player character, first information on the third location sequence, second information on the fourth location sequence, and third information on the second location sequence to the AI model. The AI model may be trained to identify, based on the first information, the second information, and the third information, that a first feature vector value associated with the first positions is closer to a second feature vector value associated with the second positions than to a third feature vector value associated with the second location sequence. The first feature vector value may represent a first path sequentially connecting the first positions. The second feature vector value may represent a second path sequentially connecting the second positions. The third feature vector value may represent a third path sequentially connecting the positions included in the second location sequence.

For example, the first information may include first timing data randomly determined in a reference range, the first timing data being linked to each of the first positions included in the third location sequence. The second information may include second timing data determined based on the first timing data included in the first information, the second timing data being linked to each of the second positions included in the fourth location sequence. The third information may include third timing data randomly determined in the reference range, the third timing data being linked to each of the positions included in the second location sequence.

For example, the instructions, when executed by the at least one processor individually or collectively, may cause the electronic device to, by dividing the first location sequence, obtain a fifth location sequence corresponding to a first portion of the first location sequence and a sixth location sequence corresponding to a second portion of the first location sequence, following the first portion of the first location sequence. The instructions, when executed by the at least one processor individually or collectively, may cause the electronic device to provide, for training the AI model, fourth information on the fifth location sequence and fifth information on the sixth location sequence to the AI model.

For example, the AI model may be trained to identify that a fourth feature vector value representing a fourth path sequentially connecting positions included in the first portion of the first location sequence is associated with a fifth feature vector value representing a fifth path sequentially connecting positions included in the second portion of the first location sequence.

For example, the instructions, when executed by the at least one processor individually or collectively, may cause the electronic device to obtain a seventh location sequence by masking a portion of the first positions included in the third location sequence. The instructions, when executed by the at least one processor individually or collectively, may cause the electronic device to provide, for training the AI model, sixth information on the seventh location sequence and seventh information on a location of the portion of the first positions masked in the seventh location sequence.

For example, the AI model may be trained to identify, based on the sixth information and the seventh information, that a sixth feature vector value representing a sixth path sequentially connecting positions included in the seventh location sequence is associated with the first feature vector value.

For example, the instructions, when executed by the at least one processor individually or collectively, may cause the electronic device to identify, using the trained AI model, feature vector values respectively representing trajectories of played characters. The instructions, when executed by the at least one processor individually or collectively, may cause the electronic device to identify a distance between a feature vector value of the feature vector values and another feature vector value of the feature vector values.

For example, the instructions, when executed by the at least one processor individually or collectively, may cause the electronic device to, in accordance with identifying the distance, based on identifying that a distance between a seventh feature vector value of the feature vector values and an eighth feature vector value of the feature vector values is less than a threshold distance, identify that the seventh feature vector value and the eighth feature vector value are included in a cluster.

For example, the instructions, when executed by the at least one processor individually or collectively, may cause the electronic device to, in accordance with identifying the distance, based on identifying that a distance between the seventh feature vector value and a ninth feature vector value of the feature vector values is greater than the threshold distance, identify that the ninth feature vector value is not included in the cluster.

For example, the threshold distance may be scalable.

For example, the electronic device may further comprise a display. The instructions, when executed by the at least one processor individually or collectively, may cause the electronic device to, based on identifying that the seventh feature vector value and the eighth feature vector value are included the cluster, display, via the display, information on a player character associated with the seventh feature vector value and a player character associated with the eighth feature vector value.

For example, the electronic device may further comprise a display. The instructions, when executed by the at least one processor individually or collectively, may cause the electronic device to, in accordance with identifying the distance, display, via the display, a map representing a positional relationship between the feature vector values. The cluster may be represented within the map.

For example, the cluster may be visually distinct from another cluster identified in accordance with identifying the distance within the map.

For example, the map may include information on positions included in a trajectory represented by the seventh feature vector value and information on positions included in a trajectory represented by the eighth feature vector value. As an example, the map may include information on positions included in a trajectory represented by the ninth feature vector value.

For example, the electronic device may further comprise a display. The instructions, when executed by the at least one processor individually or collectively, may cause the electronic device to receive a first input representing an identifier of a player character associated with the seventh feature vector value. The instructions, when executed by the at least one processor individually or collectively, may cause the electronic device to display, based on the first input, via the display, information representing that the seventh feature vector value is included in the cluster.

For example, the instructions, when executed by the at least one processor individually or collectively, may cause the electronic device to receive a second input representing an identifier of a player character associated with the ninth feature vector value. The instructions, when executed by the at least one processor individually or collectively, may cause the electronic device to display, based on the second input, via the display, information representing that the ninth feature vector value is not included in the cluster.

For example, the instructions, when executed by the at least one processor individually or collectively, may cause the electronic device to display, based on the first input, via the display, information on a player character associated with the eighth feature vector value included in the cluster.

For example, each of the positions included in the first location sequence may be represented by an identifier corresponding to an area within the game environment, including each of the positions in the first location sequence and a coordinate of each of the positions in the first location sequence, defined for the area within the game environment including each of the positions in the first location sequence.

For example, each of the positions included in the second location sequence may be represented by an identifier corresponding to an area within the game environment, including each of the positions in the second location sequence and a coordinate of each of the positions in the second location sequence, defined for the area within the game environment including each of the positions in the second location sequence.

For example, each of the positions included in the third location sequence may be represented by an identifier corresponding to an area within the game environment, including each of the positions in the third location sequence and a coordinate of each of the positions in the third location sequence, defined for the area within the game environment including each of the positions in the third location sequence.

For example, each of the positions included in the fourth location sequence may be represented by an identifier corresponding to an area within the game environment, including each of the positions in the fourth location sequence and a coordinate of each of the positions in the fourth location sequence, defined for the area within the game environment including each of the positions in the fourth location sequence.

According to an embodiment, a non-transitory computer readable storage medium storing one or more programs is provided. The one or more programs may include instructions which, when executed by at least one processor of an electronic device, cause the electronic device to identify a first location sequence including positions within a game environment, through which a first player character moves sequentially. The one or more programs may include instructions which, when executed by the at least one processor, cause the electronic device to identify a second location sequence including positions within a game environment through which a second player character different from the first player character moves sequentially.

For example, the one or more programs may include instructions which, when executed by the at least one processor, cause the electronic device to, by dividing the first location sequence, obtain a third location sequence including first positions from among the positions included in the first location sequence, and a fourth location sequence including second positions from among the positions included in the first location sequence. The first positions and the second positions may be determined alternately.

For example, the one or more programs may include instructions which, when executed by the at least one processor, cause the electronic device to provide, for training an artificial intelligence (AI) model to be used to identify a feature vector value for a trajectory of a player character, first information on the third location sequence, second information on the fourth location sequence, and third information on the second location sequence to the AI model.

For example, the AI model may be trained to identify, based on the first information, the second information, and the third information, that a first feature vector value associated with the first positions is closer to a second feature vector value associated with the second positions than to a third feature vector value associated with the second location sequence. The first feature vector value may represent a first path sequentially connecting the first positions. The second feature vector value may represent a second path sequentially connecting the second positions. The third feature vector value may represent a third path sequentially connecting the positions included in the second location sequence.

For example, the first information may include first timing data randomly determined in a reference range, the first timing data being linked to each of the first positions included in the third location sequence.

For example, the second information may include second timing data determined based on the first timing data included in the first information, the second timing data being linked to each of the second positions included in the fourth location sequence.

For example, the third information may include third timing data randomly determined in the reference range, the third timing data being linked to each of the positions included in the second location sequence.

For example, the one or more programs may include instructions which, when executed by at least one processor, cause the electronic device to, by dividing the first location sequence, obtain a fifth location sequence corresponding to a first portion of the first location sequence and a sixth location sequence corresponding to a second portion of the first location sequence, following the first portion of the first location sequence. The one or more programs may include instructions which, when executed by at least one processor, cause the electronic device to provide, for training the AI model, fourth information on the fifth location sequence and fifth information on the sixth location sequence to the AI model.

For example, the AI model may be trained to identify that a fourth feature vector value representing a fourth path sequentially connecting positions included in the first portion of the first location sequence is associated with a fifth feature vector value representing a fifth path sequentially connecting positions included in the second portion of the first location sequence.

For example, the one or more programs may include instructions which, when executed by at least one processor, cause the electronic device to obtain a seventh location sequence by masking a portion of the first positions included in the third location sequence. The one or more programs may include instructions which, when executed by at least one processor, cause the electronic device to provide, for training the AI model, sixth information on the seventh location sequence and seventh information on a location of the portion of the first positions masked in the seventh location sequence.

For example, the AI model may be trained to identify, based on the sixth information and the seventh information, that a sixth feature vector value representing a sixth path sequentially connecting positions included in the seventh location sequence is associated with the first feature vector value.

For example, the one or more programs may include instructions which, when executed by at least one processor, cause the electronic device to identify, using the trained AI model, feature vector values respectively representing trajectories of played characters. The one or more programs may include instructions which, when executed by at least one processor, cause the electronic device to identify a distance between a feature vector value of the feature vector values and another feature vector value of the feature vector values.

For example, the one or more programs may include instructions which, when executed by at least one processor, cause the electronic device to, in accordance with identifying the distance, based on identifying that a distance between a seventh feature vector value of the feature vector values and an eighth feature vector value of the feature vector values is less than a threshold distance, identify that the seventh feature vector value and the eighth feature vector value are included in a cluster.

For example, the one or more programs may include instructions which, when executed by at least one processor, cause the electronic device to, in accordance with identifying the distance, based on identifying that a distance between the seventh feature vector value and a ninth feature vector value of the feature vector values is greater than the threshold distance, identify that the ninth feature vector value is not included in the cluster.

For example, the electronic device may further comprise a display. The one or more programs may include instructions which, when executed by at least one processor, cause the electronic device to, based on identifying that the seventh feature vector value and the eighth feature vector value are included the cluster, display, via the display, information on a player character associated with the seventh feature vector value and a player character associated with the eighth feature vector value.

According to an embodiment, a method performed by an electronic device is provided. The method may comprise identifying a first location sequence including positions within a game environment, through which a first player character moves sequentially. The method may comprise identifying a second location sequence including positions within a game environment through which a second player character different from the first player character moves sequentially.

For example, the method may comprise, by dividing the first location sequence, obtaining a third location sequence including first positions from among the positions included in the first location sequence, and a fourth location sequence including second positions from among the positions included in the first location sequence. The first positions and the second positions may be determined alternately.

For example, the method may comprise providing, for training an artificial intelligence (AI) model to be used to identify a feature vector value for a trajectory of a player character, first information on the third location sequence, second information on the fourth location sequence, and third information on the second location sequence to the AI model.

For example, the AI model may be trained to identify, based on the first information, the second information, and the third information, that a first feature vector value associated with the first positions is closer to a second feature vector value associated with the second positions than to a third feature vector value associated with the second location sequence. For example, the first feature vector value may represent a first path sequentially connecting the first positions. The second feature vector value may represent a second path sequentially connecting the second positions. The third feature vector value may represent a third path sequentially connecting the positions included in the second location sequence.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one processor including processing circuitry, and
memory comprising one or more storage media storing instructions,
wherein the instructions, when executed by the at least one processor individually or collectively, cause the electronic device to:
identify a first location sequence including positions within a game environment, through which a first player character moves sequentially;
identify a second location sequence including positions within a game environment through which a second player character different from the first player character moves sequentially;
by dividing the first location sequence, obtain a third location sequence including first positions from among the positions included in the first location sequence, and a fourth location sequence including second positions from among the positions included in the first location sequence; and
provide, for training an artificial intelligence (AI) model to be used to identify a feature vector value for a trajectory of a player character, first information on the third location sequence, second information on the fourth location sequence, and third information on the second location sequence to the AI model, and
wherein the AI model is trained to identify, based on the first information, the second information, and the third information, that a first feature vector value associated with the first positions is closer to a second feature vector value associated with the second positions than to a third feature vector value associated with the second location sequence.

2. The electronic device of claim 1, wherein the first information includes first timing data randomly determined in a reference range, the first timing data being linked to each of the first positions included in the third location sequence,
wherein the second information includes second timing data determined based on the first timing data included in the first information, the second timing data being linked to each of the second positions included in the fourth location sequence, and
wherein the third information includes third timing data randomly determined in the reference range, the third timing data being linked to each of the positions included in the second location sequence.

3. The electronic device of claim 1, wherein the instructions, when executed by the at least one processor individually or collectively, cause the electronic device to:
by dividing the first location sequence, obtain a fifth location sequence corresponding to a first portion of the first location sequence and a sixth location sequence corresponding to a second portion of the first location sequence, following the first portion of the first location sequence; and
provide, for training the AI model, fourth information on the fifth location sequence and fifth information on the sixth location sequence to the AI model, and
wherein the AI model is trained to identify that a fourth feature vector value representing a fourth path sequentially connecting positions included in the first portion of the first location sequence is associated with a fifth feature vector value representing a fifth path sequentially connecting positions included in the second portion of the first location sequence.

4. The electronic device of claim 1, wherein the instructions, when executed by the at least one processor individually or collectively, cause the electronic device to:
obtain a seventh location sequence by masking a portion of the first positions included in the third location sequence; and
provide, for training the AI model, sixth information on the seventh location sequence and seventh information on a location of the portion of the first positions masked in the seventh location sequence, and
wherein the AI model is trained to identify, based on the sixth information and the seventh information, that a sixth feature vector value representing a sixth path sequentially connecting positions included in the seventh location sequence is associated with the first feature vector value.

5. The electronic device of claim 1, wherein the instructions, when executed by the at least one processor individually or collectively, cause the electronic device to:
identify, using the trained AI model, feature vector values respectively representing trajectories of played characters;
identify a distance between a feature vector value of the feature vector values and another feature vector value of the feature vector values;
in accordance with identifying the distance, based on identifying that a distance between a seventh feature vector value of the feature vector values and an eighth feature vector value of the feature vector values is less than a threshold distance, identify that the seventh feature vector value and the eighth feature vector value are included in a cluster; and
in accordance with identifying the distance, based on identifying that a distance between the seventh feature vector value and a ninth feature vector value of the feature vector values is greater than the threshold distance, identify that the ninth feature vector value is not included in the cluster.

6. The electronic device of claim 1, wherein the first positions and the second positions are determined alternately,
wherein the first feature vector value represents a first path sequentially connecting the first positions,
wherein the second feature vector value represents a second path sequentially connecting the second positions, and
wherein the third feature vector represents a third path sequentially connecting the positions included in the second location sequence.

7. The electronic device of claim 5, wherein the electronic device further comprises a display, and
wherein the instructions, when executed by the at least one processor individually or collectively, cause the electronic device to:
based on identifying that the seventh feature vector value and the eighth feature vector value are included the cluster, display, via the display, information on a player character associated with the seventh feature vector value and a player character associated with the eighth feature vector value.

8. The electronic device of claim 5, wherein the electronic device further comprises a display, and
wherein the instructions, when executed by the at least one processor individually or collectively, cause the electronic device to:
in accordance with identifying the distance, display, via the display, a map representing a positional relationship between the feature vector values, and
wherein the cluster is represented within the map.

9. The electronic device of claim 8, wherein the cluster is visually distinct from another cluster identified in accordance with identifying the distance within the map.

10. The electronic device of claim 8, wherein the map includes information on positions included in a trajectory represented by the seventh feature vector value and information on positions included in a trajectory represented by the eighth feature vector value.

11. The electronic device of claim 5, wherein the electronic device further comprises a display, and
wherein the instructions, when executed by the at least one processor individually or collectively, cause the electronic device to:
receive a first input representing an identifier of a player character associated with the seventh feature vector value;
display, based on the first input, via the display, information representing that the seventh feature vector value is included in the cluster;
receive a second input representing an identifier of a player character associated with the ninth feature vector value; and
display, based on the second input, via the display, information representing that the ninth feature vector value is not included in the cluster.

12. The electronic device of claim 11, wherein the instructions, when executed by the at least one processor individually or collectively, cause the electronic device to:
display, based on the first input, via the display, information on a player character associated with the eighth feature vector value included in the cluster.

13. The electronic device of claim 1, wherein each of the positions included in the first location sequence is represented by an identifier corresponding to an area within the game environment, including each of the positions in the first location sequence and a coordinate of each of the positions in the first location sequence, defined for the area within the game environment including each of the positions in the first location sequence,
wherein each of the positions included in the second location sequence is represented by an identifier corresponding to an area within the game environment, including each of the positions in the second location sequence and a coordinate of each of the positions in the second location sequence, defined for the area within the game environment including each of the positions in the second location sequence,
wherein each of the positions included in the third location sequence is represented by an identifier corresponding to an area within the game environment, including each of the positions in the third location sequence and a coordinate of each of the positions in the third location sequence, defined for the area within the game environment including each of the positions in the third location sequence, and
wherein each of the positions included in the fourth location sequence is represented by an identifier corresponding to an area within the game environment, including each of the positions in the fourth location sequence and a coordinate of each of the positions in the fourth location sequence, defined for the area within the game environment including each of the positions in the fourth location sequence.

14. A non-transitory computer readable storage medium storing one or more programs, wherein the one or more programs include instructions which, when executed by at least one processor of an electronic device, cause the electronic device to:
identify a first location sequence including positions within a game environment, through which a first player character moves sequentially;
identify a second location sequence including positions within a game environment through which a second player character different from the first player character moves sequentially;
by dividing the first location sequence, obtain a third location sequence including first positions from among the positions included in the first location sequence, and a fourth location sequence including second positions from among the positions included in the first location sequence; and
provide, for training an artificial intelligence (AI) model to be used to identify a feature vector value for a trajectory of a player character, first information on the third location sequence, second information on the fourth location sequence, and third information on the second location sequence to the AI model, and
wherein the AI model is trained to identify, based on the first information, the second information, and the third information, that a first feature vector value associated with the first positions is closer to a second feature vector value associated with the second positions than to a third feature vector value associated with the second location sequence.

15. The non-transitory computer readable storage medium of the claim 14, wherein the first information includes first timing data randomly determined in a reference range, the first timing data being linked to each of the first positions included in the third location sequence,
wherein the second information includes second timing data determined based on the first timing data included in the first information, the second timing data being linked to each of the second positions included in the fourth location sequence, and
wherein the third information includes third timing data randomly determined in the reference range, the third timing data being linked to each of the positions included in the second location sequence.

16. The non-transitory computer readable storage medium of the claim 14, wherein the one or more programs include instructions which, when executed by at least one processor, cause the electronic device to:
by dividing the first location sequence, obtain a fifth location sequence corresponding to a first portion of the first location sequence and a sixth location sequence corresponding to a second portion of the first location sequence, following the first portion of the first location sequence; and
provide, for training the AI model, fourth information on the fifth location sequence and fifth information on the sixth location sequence to the AI model, and
wherein the AI model is trained to identify that a fourth feature vector value representing a fourth path sequentially connecting positions included in the first portion of the first location sequence is associated with a fifth feature vector value representing a fifth path sequentially connecting positions included in the second portion of the first location sequence.

17. The non-transitory computer readable storage medium of claim 14, wherein the one or more programs include instructions which, when executed by at least one processor, cause the electronic device to:
obtain a seventh location sequence by masking a portion of the first positions included in the third location sequence; and
provide, for training the AI model, sixth information on the seventh location sequence and seventh information on a location of the portion of the first positions masked in the seventh location sequence, and
wherein the AI model is trained to identify, based on the sixth information and the seventh information, that a sixth feature vector value representing a sixth path sequentially connecting positions included in the seventh location sequence is associated with the first feature vector value.

18. The non-transitory computer readable storage medium of claim 14, wherein the one or more programs include instructions which, when executed by at least one processor, cause the electronic device to:
identify, using the trained AI model, feature vector values respectively representing trajectories of played characters;
identify a distance between a feature vector value of the feature vector values and another feature vector value of the feature vector values;
in accordance with identifying the distance, based on identifying that a distance between a seventh feature vector value of the feature vector values and an eighth feature vector value of the feature vector values is less than a threshold distance, identify that the seventh feature vector value and the eighth feature vector value are included in a cluster; and
in accordance with identifying the distance, based on identifying that a distance between the seventh feature vector value and a ninth feature vector value of the feature vector values is greater than the threshold distance, identify that the ninth feature vector value is not included in the cluster.

19. The non-transitory computer readable storage medium of claim 18, wherein the electronic device further comprises a display, and
wherein the one or more programs include instructions which, when executed by at least one processor, cause the electronic device to:
based on identifying that the seventh feature vector value and the eighth feature vector value are included the cluster, display, via the display, information on a player character associated with the seventh feature vector value and a player character associated with the eighth feature vector value.

20. A method performed by an electronic device, comprising:
identifying a first location sequence including positions within a game environment, through which a first player character moves sequentially;
identifying a second location sequence including positions within a game environment through which a second player character different from the first player character moves sequentially;
by dividing the first location sequence, obtaining a third location sequence including first positions from among the positions included in the first location sequence, and a fourth location sequence including second positions from among the positions included in the first location sequence; and
providing, for training an artificial intelligence (AI) model to be used to identify a feature vector value for a trajectory of a player character, first information on the third location sequence, second information on the fourth location sequence, and third information on the second location sequence to the AI model, and
wherein the AI model is trained to identify, based on the first information, the second information, and the third information, that a first feature vector value associated with the first positions is closer to a second feature vector value associated with the second positions than to a third feature vector value associated with the second location sequence.
